(19) United States
(12) Patent Application Publication
(10) Pub. No.: US 2026/0062075 A1
(43) Pub. Date: Mar. 5, 2026

(54) PERFORMANCE OF DOCKING MANEUVERS BY LEGGED ROBOTS USING DOCK ASSOCIATIONS

(71) Applicant: Boston Dynamics, Inc., Waltham, MA (US)

(72) Inventors: Emily Charles, Watertown, MA (US); Arun Kumar, Waltham, MA (US); Samuel Frank Seifert, Lincoln, MA (US); Matthew Reid, Waltham, MA (US); Brian Ringley, Copiague, NY (US)

(21) Appl. No.: 19/316,552

(22) Filed: Sep. 2, 2025

Related U.S. Application Data
(60) Provisional application No. 63/690,213, filed on Sep. 3, 2024.

(51) Int. Cl. B62D 57/032; B25J 9/00; B25J 9/16

(52) U.S. Cl. CPC B62D 57/032; B25J 9/0009; B25J 9/161

(57) ABSTRACT

Systems and methods are described for docking a legged robot. A system can obtain sensor data from one or more sensors of the legged robot. The system can obtain dock association data associated with the legged robot. The dock association data may indicate an association of two or more docks to the legged robot. Based on the dock association data, the system can identify a dock of the two or more docks. The system can instruct the legged robot to perform a docking maneuver relative to the dock based on the sensor data and based on identifying the dock. For example, the system can instruct the legged robot to dock at the dock.

### CROSS REFERENCE TO RELATED APPLICATION

This U.S. patent application claims priority under 35 U.S.C. § 119 (e) to U.S. Provisional Application No. 63/690,213, filed Sep. 3, 2024, which is considered part of the disclosure of this application and is hereby incorporated by reference in its entirety.

### TECHNICAL FIELD

This disclosure relates generally to robotics, and more specifically, to systems, methods, and apparatuses, including computer programs, for performance of docking maneuvers by robots.

### BACKGROUND

Robotic devices can autonomously or semi-autonomously navigate environments to perform a variety of tasks or functions. As robotic devices become more prevalent, there is a need to dock the robotic devices prior to, during, and/or after performance of the tasks or functions.

### SUMMARY

An aspect of the present disclosure provides a method. The method may include obtaining, by data processing hardware of a legged robot, first sensor data associated with an environment of the legged robot. The method may further include obtaining, by the data processing hardware, dock association data associated with the legged robot. The dock association data may indicate an association of two or more docks to the legged robot. The method may further include identifying, by the data processing hardware, a first dock of the two or more docks based on the dock association data. The method may further include instructing, by the data processing hardware, the legged robot to perform a first docking maneuver relative to the first dock based on the first sensor data and identifying the first dock.

In various embodiments, a fleet of legged robots may include the legged robot. The environment of the legged robot may include a set of docks. Each legged robot of the fleet of legged robots may be associated with a respective subset of the set of docks according to respective dock association data for each legged robot.

In various embodiments, the dock association data may further indicate that the legged robot is eligible to perform the first docking maneuver at the two or more docks. The dock association data may further indicate that the legged robot is ineligible to perform the first docking maneuver at a second dock in the environment of the legged robot.

In various embodiments, the dock association data may further indicate docks at which the legged robot is permitted to perform the first docking maneuver.

In various embodiments, the association of the two or more docks to the legged robot may be an exclusive association of the two or more docks to the legged robot.

In various embodiments, the dock association data may further indicate one or more flags associated with the legged robot.

In various embodiments, the dock association data may further indicate an association of a subset of the two or more docks to the legged robot as mission continuation docks.

In various embodiments, the dock association data may further indicate an association of a subset of the two or more docks to the legged robot as mission termination docks.

In various embodiments, the dock association data may further indicate, for each respective dock of the two or more docks, an identifier of a respective route waypoint associated with the respective dock.

In various embodiments, the dock association data may further indicate, for each respective dock of the two or more docks, an identifier of the respective dock.

In various embodiments, the dock association data may further indicate, for each respective dock of the two or more docks, one or more strings indicating the respective dock.

In various embodiments, the dock association data may further indicate, for each respective dock of the two or more docks, one or more docking parameters associated with the respective dock.

In various embodiments, identifying the first dock may further be based on a distance between a location associated with the first dock and a location associated with the legged robot.

In various embodiments, the method may further include determining, for each respective dock of the two or more docks, a distance between a location associated with the legged robot and a location associated with the respective dock. Identifying the first dock may further be based on determining, for each respective dock of the two or more docks, the distance between the location associated with the legged robot and the location associated with the respective dock.

In various embodiments, the method may further include determining, for each respective dock of the two or more docks, a distance between a location associated with the legged robot and a location associated with the respective dock. The method may further include comparing the distances between the location associated with the legged robot and the locations associated with the two or more docks. Identifying the first dock may further be based on comparing the distances between the location associated with the legged robot and the locations associated with the two or more docks.

In various embodiments, the method may further include obtaining a map. The map may indicate the two or more docks. Identifying the first dock may further be based on the map.

In various embodiments, the method may further include obtaining a map. The map may indicate the two or more docks and a second dock. Identifying the first dock may further be based on the map.

In various embodiments, the method may further include obtaining a map. The map may indicate the two or more docks and a second dock. The second dock may be associated with a second legged robot. Identifying the first dock may further be based on the map.

In various embodiments, the method may further include determining battery data associated with the legged robot. Instructing the legged robot to perform the first docking maneuver may further be based on the battery data.

In various embodiments, the method may further include obtaining mission data associated with the legged robot. The mission data may be indicative of a mission associated with the legged robot. Instructing the legged robot to perform the first docking maneuver may further be based on the mission data.

In various embodiments, the method may further include obtaining mission data associated with the legged robot. The mission data may be indicative of a mission associated with the legged robot. The mission data may indicate a set of route waypoints, one or more route edges, and one or more actions. Each of the one or more route edges may connect two respective waypoints of the set of route waypoints. Instructing the legged robot to perform the first docking maneuver may further be based on performance of an action of the one or more actions.

In various embodiments, the method may further include obtaining mission data associated with the legged robot. The mission data may be indicative of a mission associated with the legged robot. The mission data may indicate a set of route waypoints, one or more route edges, and the first dock. Instructing the legged robot to perform the first docking maneuver may further be based on the mission data.

In various embodiments, the method may further include obtaining mission data associated with the legged robot. The mission data may be indicative of a mission associated with the legged robot. The mission data may indicate a set of route waypoints, one or more route edges, and one or more docks. The method may further include generating updated mission data associated with the legged robot. The updated mission data may indicate the set of route waypoints, the one or more route edges, the one or more docks, and the first dock. Instructing the legged robot to perform the first docking maneuver may further be based on the updated mission data.

In various embodiments, the method may further include generating mission data associated with the legged robot. The mission data may be indicative of a mission associated with the legged robot. The mission data may indicate a set of route waypoints, one or more route edges, and the first dock. Instructing the legged robot to perform the first docking maneuver may further be based on the mission data.

The method of claim 1, further comprising:

In various embodiments, the method may further include generating mission data associated with the legged robot. The mission data may be indicative of a mission associated with the legged robot. The mission data may indicate a set of route waypoints, one or more route edges, and the two or more docks. Instructing the legged robot to perform the first docking maneuver may further be based on the mission data.

In various embodiments, the method may further include generating mission data associated with the legged robot. The mission data may be indicative of a mission associated with the legged robot. The mission data may indicate a set of route waypoints, one or more route edges, and the two or more docks. The mission may further indicate, for each respective dock of the two or more docks, that the respective dock includes a mission continuation dock or a mission termination dock. Instructing the legged robot to perform the first docking maneuver may further be based on the mission data.

In various embodiments, the method may further include obtaining mission data associated with the legged robot. The mission data may be indicative of a mission associated with the legged robot. The mission data may indicate a set of route waypoints, one or more route edges, and one or more actions. Each of the one or more route edges may connect two respective waypoints of the set of route waypoints. Instructing the legged robot to perform the first docking maneuver may further be based on an anomaly associated with performance of an action of the one or more actions.

In various embodiments, the first docking maneuver may include an autonomous docking maneuver.

In various embodiments, the first docking maneuver may be associated with mission termination.

In various embodiments, the first docking maneuver may be associated with mission continuation.

In various embodiments, instructing the legged robot to perform the first docking maneuver may include instructing the legged robot to dock at the first dock. Instructing the legged robot to perform the first docking maneuver may further include instructing the legged robot to traverse the environment of the legged robot based on docking at the first dock.

In various embodiments, instructing the legged robot to perform the first docking maneuver may include instructing the legged robot to dock at the first dock. Instructing the legged robot to perform the first docking maneuver may further include instructing the legged robot to terminate a mission of the legged robot based on docking at the first dock.

In various embodiments, the dock association data may further indicate an association of a first subset of the two or more docks to the legged robot as mission continuation docks and an association of a second subset of the two or more docks to the legged robot as mission termination docks.

In various embodiments, the method may further include instructing display of a user interface. The user interface may indicate the two or more docks.

In various embodiments, the method may further include instructing display of a user interface via a user computing device. The user interface may indicate the two or more docks. The method may further include obtaining, from the user computing device, an input. The input may indicate a selection of the first dock from the two or more docks.

In various embodiments, the method may further include instructing display of a user interface via a user computing device. The user interface may indicate the two or more docks. The method may further include obtaining, from the user computing device, an input. The input may indicate a selection of the first dock from the two or more docks. Identifying the first dock may further be based on the selection.

In various embodiments, the method may further include obtaining mission data associated with the legged robot. The mission data may be indicative of a mission associated with the legged robot. Identifying the first dock may further be based on the mission data.

In various embodiments, the method may further include obtaining one or more dock identifiers based on the dock association data. The one or more dock identifiers may indicate the two or more docks. The method may further include obtaining mission data associated with the legged robot. The mission data may be indicative of a mission associated with the legged robot. The mission data may indicate a set of route waypoints, one or more route edges, and one or more actions. Each of the one or more route edges may connect two respective waypoints of the set of route waypoints. The method may further include determining that a route edge of the one or more route edges is obstructed. The method may further include updating the one or more dock identifiers based on determining that the route edge is obstructed. Identifying the first dock may further be based on the mission data.

In various embodiments, the method may further include obtaining one or more dock identifiers based on the dock association data. The one or more dock identifiers may indicate the two or more docks. The method may further include obtaining mission data associated with the legged robot. The mission data may be indicative of a mission associated with the legged robot. The mission data may indicate a set of route waypoints, one or more route edges, and one or more actions. Each of the one or more route edges may connect two respective waypoints of the set of route waypoints. The method may further include determining that a route edge of the one or more route edges is obstructed. The method may further include updating the one or more dock identifiers based on determining that the route edge is obstructed. Identifying the first dock may further be based on the mission data. The method may further include updating the mission data based on determining that the route edge is obstructed.

In various embodiments, the method may further include obtaining one or more dock identifiers based on the dock association data. The one or more dock identifiers may indicate the two or more docks. The method may further include obtaining mission data associated with the legged robot. The mission data may be indicative of a mission associated with the legged robot. The mission data may indicate a set of route waypoints, one or more route edges, and one or more actions. Each of the one or more route edges may connect two respective waypoints of the set of route waypoints. The method may further include determining that a route edge of the one or more route edges is obstructed. The method may further include updating the one or more dock identifiers based on determining that the route edge is obstructed to obtain one or more updated dock identifiers. Identifying the first dock may further be based on the mission data. The method may further include updating the mission data based on determining that the route edge is obstructed to obtain updated mission data. The method may further include resetting the one or more dock identifiers based on at least one of the one or more updated dock identifiers or the updated mission data.

In various embodiments, the method may further include obtaining one or more dock identifiers based on the dock association data. The one or more dock identifiers may indicate the two or more docks. The method may further include determining that a second dock of the two or more docks is occupied. The method may further include updating the one or more dock identifiers to remove an identifier of the second dock from the one or more dock identifiers based on determining that the second dock is occupied.

In various embodiments, the method may further include obtaining one or more dock identifiers based on the dock association data. The one or more dock identifiers may indicate the two or more docks. The method may further include determining that access to a second dock of the two or more docks is obstructed. The method may further include updating the one or more dock identifiers to remove an identifier of the second dock from the one or more dock identifiers based on determining that access to the second dock is obstructed.

In various embodiments, the method may further include identifying a second dock of the two or more docks based on the dock association data. The method may further include determining that access to the second dock is obstructed. Identifying the first dock may further be based on determining that access to the second dock is obstructed.

In various embodiments, the method may further include obtaining one or more dock identifiers based on the dock association data. The one or more dock identifiers may indicate the two or more docks. The method may further include identifying an anomaly associated with a second docking maneuver relative to a second dock of the two or more docks. The method may further include updating the one or more dock identifiers to remove an identifier of the second dock from the one or more dock identifiers based on identifying the anomaly.

In various embodiments, obtaining the dock association data may include obtaining the dock association data from a user computing device.

In various embodiments, the method may further include identifying a set of docks in the environment of the legged robot. The method may further include instructing display of a user interface via a user computing device. The user interface may indicate the set of docks. Obtaining the dock association data may include obtaining the dock association data from the user computing device.

In various embodiments, the method may further include identifying a set of docks in the environment of the legged robot. The method may further include instructing display of a user interface via a user computing device. The user interface may indicate the set of docks. Obtaining the dock association data may include obtaining the dock association data from the user computing device based on a selection of the two or more docks from the set of docks.

In various embodiments, the method may further include determining a set of docks are associated with the environment of the legged robot. The method may further include instructing display, via a user computing device, of a user interface indicating the set of docks based on determining the set of docks are associated with the environment of the legged robot. Obtaining the dock association data may include obtaining the dock association data from the user computing device based on a selection of the two or more docks from the set of docks.

In various embodiments, the method may further include transmitting a request for an identifier of a dock associated with the legged robot. Obtaining the dock association data may be based on the request.

In various embodiments, the method may further include identifying performance of a second docking maneuver relative to the first dock. The method may further include generating the dock association data based on the performance of the second docking maneuver.

In various embodiments, the method may further include identifying a request to perform a second docking maneuver relative to the first dock. The request may indicates that the second docking maneuver is associated with mission continuation or mission termination. The method may further include generating the dock association data based on the request.

In various embodiments, the method may further include dynamically assigning the two or more docks to the legged robot. The method may further include generating the dock association data based on dynamically assigning the two or more docks to the legged robot.

In various embodiments, the method may further include obtaining a dynamic association of the two or more docks to the legged robot. The method may further include generating the dock association data based on the dynamic association of the two or more docks to the legged robot.

In various embodiments, the dock association data may be based on the first sensor data.

In various embodiments, the method may further include obtaining second sensor data. The method may further include generating a pictorial representation of the environment of the legged robot based on the second sensor data and the dock association data. The method may further include instructing display of the pictorial representation via a user computing device.

In various embodiments, the method may further include obtaining second sensor data. The method may further include generating a pictorial representation of the environment of the legged robot based on the second sensor data and the dock association data. The pictorial representation may indicate an association status of a second dock in the environment. The method may further include instructing display of the pictorial representation via a user computing device.

In various embodiments, the method may further include obtaining second sensor data. The method may further include generating a pictorial representation of the environment of the legged robot based on the second sensor data and the dock association data. The pictorial representation may indicate an association status of a second dock in the environment. The association status may indicate that the second dock is associated with the legged robot or is associated with a different legged robot. The method may further include instructing display of the pictorial representation via a user computing device.

According to various embodiments of the present disclosure, a robot may include data processing hardware and memory in communication with the data processing hardware. The memory may store instructions that when executed on the data processing hardware cause the data processing hardware to obtain first sensor data associated with an environment of a legged robot. Execution of the instructions may further cause the data processing hardware to obtain dock association data associated with the legged robot. The dock association data may indicate an association of two or more docks to the legged robot. Execution of the instructions may further cause the data processing hardware to identify a first dock of the two or more docks based on the dock association data. Execution of the instructions may further cause the data processing hardware to instruct the legged robot to perform a first docking maneuver relative to the first dock based on the first sensor data and identifying the first dock.

In various embodiments, the system may further include any combination of the features discussed herein.

According to various embodiments of the present disclosure, a legged robot may include data processing hardware and memory in communication with the data processing hardware. The memory may store instructions that when executed on the data processing hardware cause the data processing hardware to obtain first sensor data associated with an environment of the legged robot. Execution of the instructions may further cause the data processing hardware to obtain dock association data associated with the legged robot. The dock association data may indicate an association of two or more docks to the legged robot. Execution of the instructions may further cause the data processing hardware to identify a first dock of the two or more docks based on the dock association data. Execution of the instructions may further cause the data processing hardware to instruct the legged robot to perform a first docking maneuver relative to the first dock based on the first sensor data and identifying the first dock.

In various embodiments, the legged robot may further include any combination of the features discussed herein.

According to various embodiments of the present disclosure, a method may include obtaining, by data processing hardware, from a user computing device, a selection of a set of route waypoints, one or more route edges, and two or more docks. The method may further include generating, by the data processing hardware, mission data associated with a legged robot. The mission data may be indicative of a mission associated with the legged robot. The mission data may indicate the set of route waypoints, the one or more route edges, and the two or more docks. The method may further include instructing, by the data processing hardware, traversal of an environment by the legged robot according to the mission data.

In various embodiments, the method may further include any combination of the features discussed herein.

According to various embodiments of the present disclosure, a method may include identifying, by data processing hardware, an environment of a legged robot. The method may further include identifying, by the data processing hardware, a set of docks associated with the environment. The method may further include instructing, by the data processing hardware, display of an identifier of the set of docks via a user interface of a user computing device. The method may further include obtaining, by the data processing hardware, from the user computing device, a selection of a dock from the set of docks. The method may further include instructing, by the data processing hardware, the legged robot to perform a docking maneuver relative to the dock based on the selection of the dock.

In various embodiments, the method may further include any combination of the features discussed herein.

According to various embodiments of the present disclosure, a method may include instructing, by data processing hardware of a legged robot, the legged robot to perform a docking maneuver relative to a first dock based on a determination that the first dock is associated with the legged robot. The method may further include determining, by the data processing hardware, that access to the first dock by the legged robot is obstructed. The method may further include determining, by the data processing hardware, that a second dock is associated with the legged robot. The method may further include instructing, by the data processing hardware, the legged robot to perform the docking maneuver relative to the second dock based on determining that access to the first dock by the legged robot is obstructed and determining that the second dock is associated with the legged robot.

In various embodiments, the method may further include any combination of the features discussed herein.

According to various embodiments of the present disclosure, a method may include obtaining, by data processing hardware of a legged robot, an instruction to perform a docking maneuver relative to a dock. The method may further include determining, by the data processing hardware, that the dock is associated with the legged robot based on dock association data associated with the legged robot. The dock association data may indicate an association of two or more docks to the legged robot. The method may further include instructing, by the data processing hardware, the legged robot to perform the docking maneuver relative to the dock based on determining that the dock is associated with the legged robot.

In various embodiments, the method may further include any combination of the features discussed herein.

According to various embodiments of the present disclosure, a method may include obtaining, by data processing hardware of a legged robot, sensor data associated with an environment of the legged robot. The method may further include identifying, by the data processing hardware, two or more docks in the environment of the legged robot based on the sensor data. The method may further include generating, by the data processing hardware, dock association data associated with the legged robot based on identifying the two or more docks. The dock association data may indicate an association of the two or more docks to the legged robot. The method may further include instructing, by the data processing hardware, the legged robot to traverse the environment based on the dock association data.

In various embodiments, the method may further include any combination of the features discussed herein.

According to various embodiments of the present disclosure, a system may include data processing hardware and memory in communication with the data processing hardware. The memory may store instructions that when executed on the data processing hardware cause the data processing hardware to perform any combination of the features discussed herein.

According to various embodiments of the present disclosure, a mobile robot may include at least one sensor, at least two legs, data processing hardware, and memory in communication with the data processing hardware. The memory may store instructions that when executed on the data processing hardware cause the data processing hardware to perform any combination of the features discussed herein.

### DESCRIPTION OF DRAWINGS

FIG. 1A is a perspective view of an example robot for navigating an environment.

FIG. 1B is a schematic view of example systems of the robot of FIG. 1A.

FIG. 1C is a schematic view of an example dock.

FIG. 2A is a schematic view of an example docking system of a robot, such as the robot of FIG. 1A.

FIG. 2B is a schematic view of an example docking system of a robot, such as the robot of FIG. 1A.

FIG. 3 is a schematic view of an environment including a plurality of systems associated with a robot, such as the robot of FIG. 1A.

FIG. 4A is a schematic view of an example user interface for associating a dock and a robot.

FIG. 4B is a schematic view of an example user interface for associating a dock and a robot.

FIG. 5 is a schematic view of dock association data based on association of a dock and a robot.

FIG. 6 is a schematic view of an example user interface for selecting a dock associated with a robot.

FIG. 7 is a schematic view of an example user interface for selecting a dock associated with a robot.

FIG. 8A is a schematic view of an example user interface for generation of a mission.

FIG. 8B is a schematic view of an example user interface indicating a mission.

FIG. 8C is a schematic view of an example user interface indicating a set of missions.

FIG. 9 is a flowchart of an example arrangement of operations for instructing performance of a docking maneuver based on dock assignment data.

FIG. 10 is a schematic view of an example computing device that may be used to implement the systems and methods described herein.

Like reference symbols in the various drawings indicate like elements.

### DETAILED DESCRIPTION

Generally described, autonomous and semi-autonomous robots (e.g., battery-powered robots) can utilize mapping, localization, and/or navigation systems to map an environment (e.g., a site) utilizing sensor data obtained by the robots. For example, the robots may be mobile robots, legged robots, etc. Further, the robots can utilize the systems to perform navigation and/or localization in the environment.

In some cases, the robots can perform various actions (e.g., obtaining image data, obtaining temperature data, turning a knob, etc.) in the environment. For example, a robot may receive an input, from a user computing device, indicating one or more actions for the robot to perform.

In some cases, the robots can perform a docking maneuver (e.g., dock) at a dock to recharge the robots. For example, the docking maneuver may include adjusting a pose, orientation, and/or position of a robot and lowering the robot onto the dock (e.g., using one or more joints of one or more legs of the robot) such that one or more terminals of the robot engage with one or more terminals of the dock. The robots may perform the docking maneuver in response to input from a user computing device, in response to a determination that a battery level of a battery of the robot does not satisfy (e.g., is less than, is equal to, is outside of a range of, etc.) one or more thresholds (e.g., a threshold range, a threshold level, etc.). In some cases, the robots may receive an indication of the threshold(s) from the user computing device (e.g., the threshold may be dynamic in that different threshold(s) may be used for different missions and/or that different threshold(s) may be used within a mission for different actions). For example, the robots may receive an indication of a first threshold for a first mission and an indication of a second threshold and a third threshold for a second mission.

In some cases, the robots can obtain sensor data (e.g., image data) indicating one or more docks and may perform the docking maneuver at a particular dock of the one or more docks based on the sensor data. For example, the robots may cause display of the sensor data via a user interface, may obtain input via the user interface, and may perform the docking maneuver at the particular dock based on the input (e.g., indicating a selection of the particular dock).

In some cases, the robots can generate one or more scores for one or more docks (e.g., based on whether the robots determine that a dock is blocked, a dock is occupied, etc.) and assign a respective status to all or a portion of the one or more docks based on the one or more scores. For example, the status may be a valid status or an invalid status.

In some cases, the robots can define (e.g., generate) a mission (e.g., a robot mission, an inspection mission, a navigation mission, etc.) based on navigation of the environment and/or performance of one or more actions. For example, the robots can record a mission based on navigation in the environment and/or performance of the one or more actions such that the robots can subsequently execute the mission (e.g., autonomously reperform the navigation in the environment and/or the performance of the one or more actions).

A mission may include two or more route waypoints, one or more route edges, one or more actions, etc. For example, the mission may include navigation between a series of route waypoints (e.g., a first route waypoint and a second route waypoint) via a route edge and performance of an action (e.g., obtaining image data at a particular location, performing a docking maneuver, etc.). In some cases, a mission may not include an action, a route waypoint, etc.

In some cases, a mission may be associated with a dock (e.g., a global dock for the mission). For example, the mission may be associated with a single, global dock for the mission. The mission may be associated with (e.g., may include) a dock based on navigation by the robot to the dock and performance of a docking maneuver (e.g., at the dock) during recording of the mission. In some cases, the dock may be associated with a route waypoint of the two or more route waypoints.

In some cases, the mission may be associated with the dock such that the robots may terminate the mission at the dock. Based on association of the mission with the dock, the robots can perform the docking maneuver at the dock and terminate the mission. For example, a mission may include navigation from a first route waypoint to a dock, performance of a docking maneuver at the dock (e.g., docking), and termination of the mission based on performance of the docking maneuver.

In some cases, the mission may be associated with the dock such that the robots may navigate to the dock, perform a docking maneuver, recharge, and/or continue performance of the mission or perform the mission again. During, after, or prior to performance the mission, the robots can perform the docking maneuver at a dock associated with the mission. For example, as the robots navigate the environment and/or perform one or more actions, the robots may expend energy and may perform the docking maneuver at a dock to recharge one or more batteries of the robots. In some cases, the robot can perform the docking maneuver, recharge, and continue navigation of the environment and/or performance of one or more actions (e.g., as part of a mission).

In some cases, the mission may be associated with the dock such that the robots may recharge at the dock and/or terminate the mission at the dock. For example, the robot can perform the docking maneuver, terminate the mission, and/or recharge.

The robots may store the missions (e.g., as mission data) such that the robots can subsequently and autonomously execute the missions. For example, the robots may execute a mission based on a schedule, based on input received via a user computing device, etc.

As discussed above, in some applications, robots may perform a docking maneuver (e.g., relative to a dock) as part of an initial mission (e.g., based on input received via a user computing device requesting performance of the docking maneuver, actively providing control instructions to the robot, etc.) and/or as part of execution of a prior recorded mission (e.g., based on input received via a user computing device requesting performance of the prior recorded mission).

As an environment may include a fleet of robots operating within the environment, identifying a dock for performance of the docking maneuver by a particular robot may be difficult. For example, one or more docks within the environment may be occupied by one or more other robots of the fleet of robots such that another robot may not perform the docking maneuver at the one or more docks. The operation of such a fleet of robots may cause issues and/or inefficiencies (including computational inefficiencies, a loss of confidence in the systems and/or the robot, etc.). For example, a user may attempt to provide instructions to navigate a robot to a dock and may determine that another robot occupies the dock.

Based on the association of a single, global dock with a mission, a robot may have a coverage area (e.g., an inspection coverage area) based on a speed of the robot (e.g., walking speed), a location of the dock, and a life of a battery of the robot. For example, as the robot may navigate to the dock to recharge and/or terminate the mission, the area of the mission may be based on the coverage area of the robot. The area of the mission being based on the coverage area of the robot may cause issues and/or inefficiencies (including computational inefficiencies, a loss of confidence in the systems and/or the robot, etc.). For example, a user may request performance of a mission corresponding to an area that exceeds the coverage area of the robot. In another example, navigation back to a same dock to recharge and/or terminate the mission may be inefficient.

In some cases, a user may attempt to manually define missions that include multiple route waypoints associated with a respective dock. However, such a manual definition of the missions may not be possible and/or may result in inefficient missions as the battery level of the robot may vary over subsequent iterations of the execution of the mission. For example, during a first iteration of the mission, a robot may have a first battery level at a first route waypoint and, during a second iteration of the mission, a robot may have a second battery level at the first route waypoint such that the robot may be able to navigate to a dock and recharge during the first mission but may not be able to navigate to the dock and recharge during the second mission. Such a manual process may cause issues and/or inefficiencies (e.g., movement inefficiencies) and may be resource and time intensive and/or inefficient based on the amount of data associated with each robot and the number of robots operating within a fleet of robots.

The present disclosure relates to the performance of docking maneuvers by robots (e.g., legged robots) based on dock association data (e.g., indicating one or more dock associations). For example, the dock association data may include one or more strings, one or more key-value pairs, one or more identifiers, one or more keywords, one or more flags, etc. The dock association data may indicate an association (e.g., an assignment, a linking, a correspondence, an allocation, a designation, etc.) of one or more docks to a robot. For example, the dock association data may indicate that a first dock and a second dock are assigned to the robot. In some cases, the association may be an exclusive association indicating that the robot is exclusively associated with the one or more docks and exclusively eligible to perform a docking maneuver at the one or more docks.

The methods and apparatus described herein enable a computing system to dynamically identify and/or perform a docking maneuver at a dock based on dock association data. For example, the computing system may dynamically identify a dock by identifying (e.g., in real time) different docks for the robot such that the robot may not be limited to docking at a particular dock. Further, the computing system may cause a robot to dynamically dock at a dock by identifying a dock using one or more dock identifiers such that the robot may not be limited to docking at a particular dock. As robots proliferate, the demand for efficient and dynamic performance of docking maneuvers (e.g., dynamic docking) by the robots has increased. Specifically, the demand for robots to dynamically perform a docking maneuver at a dock of multiple docks has increased. The present disclosure provides systems and methods that enable an increase in the efficiency in the performance of the docking maneuver by the robot, the performance of missions, and the navigation of a robot within an environment (e.g., using dock association data). For example, the methods and apparatus can enable the computing system to dynamically identify a dock, instruct navigation by a robot to the dock, and instruct the robot to perform a docking maneuver relative to the dock.

To dynamically identify a dock, the computing system can obtain dock association data. For example, the computing system can obtain dock association data from a user computing device (e.g., indicating an association of a dock with a robot). In another example, the computing system can obtain the dock association data from a data store (e.g., based on an identifier associated with a robot).

In some cases, the computing system can generate the dock association data. For example, based on instructing the robot to perform a docking maneuver at a dock and/or determining that the robot performed the docking maneuver at the dock, the computing system may generate dock association data associating the dock with the robot.

In some cases, the computing system may identify one or more docks for performance of a docking maneuver by the robot (e.g., based on dock association data associating the one or more docks with the robot, based on a determination that the one or more docks are not associated with other robots, based on a determination that performance of the docking maneuver is not obstructed, etc.). Based on identifying the one or more docks for performance of the docking maneuver by the robot, the computing system may provide a user interface indicating the one or more docks, may receive an input via the user interface (e.g., indicating a selection of a dock), and may generate the dock association data based on the input. For example, based on identifying an input from a user computing device requesting performance of a docking maneuver at a dock of the one or more docks, the computing system may generate dock association data associating the dock with the robot.

As discussed herein, the dock association data may indicate two more docks associated with the robot. For example, the dock association data may indicate that two docks are associated with the robot, four docks are associated with the robot, five docks are associated with the robot, etc. In some cases, the dock association data may indicate a single dock associated with the robot.

The dock association data may further indicate two or more docks associated with the robot and located within an environment of the robot. For example, the dock association data may be environment-specific such that the computing system may identify an environment of the robot (e.g., a site of the robot) and/or may identify dock association data associated with the environment (e.g., indicating two or more docks located in the environment and associated with the robot). A system may generate one or more dock identifiers indicating one or more docks for a robot based on the dock association data.

In some cases, the dock association data may be dynamic dock association data and/or the one or more dock identifiers may be dynamic. For example, the computing system may dynamically update the dock association data and/or the one or more dock identifiers (e.g., to associate a dock with a robot, to disassociate a dock with a robot, etc.). In some cases, based on disassociating a dock with a robot, the computing system may remove the dock (e.g., an identifier of the dock) and/or an association of the dock with the robot from the dock association data and/or the one or more dock identifiers. In some cases, based on disassociating the dock with the robot, the computing system may add an identifier of the disassociation to the dock association data and/or the one or more dock identifiers.

In some cases, the computing system may identify that performance of a docking maneuver at a dock is obstructed and may update the dock association data and/or the one or more dock identifiers to disassociate (e.g., remove an association of) the dock with the robot. For example, the computing system may identify that performance of a docking maneuver at the dock is obstructed based on a determination that another robot is docked at the dock. In another example, the computing system may identify that performance of the docking maneuver is obstructed based on determining all or a portion of the route edges associated with (e.g., to) a route waypoint associated with the dock are obstructed.

In some cases, the dock association data and/or the one or more dock identifiers may indicate a type of dock and/or a type of action associated with the dock for all or a portion of the two or more docks associated with the robot. For example, the dock association data and/or the one or more dock identifiers may indicate that a dock is designated as a mission continuation dock (e.g., that the robot can recharge at the dock but may not terminate a mission at the dock) or is a mission termination dock (e.g., that the robot can recharge at the dock and continue a mission and/or may terminate the mission at the dock and recharge). In another example, the dock association data and/or the one or more dock identifiers may indicate that a dock is associated with mission continuation (e.g., that the robot can continue a mission after docking at the dock but may not terminate a mission after docking at the dock) or that the dock is associated with mission termination (e.g., that robot can continue a mission after docking at the dock and/or can terminate a mission after docking at the dock). In some cases, maneuver data (which may be separate and/or distinct from the dock association data and/or the one or more dock identifiers) may indicate a type of dock and/or a type of action associated with the dock. For example, the computing system may obtain and/or store the maneuver data.

As discussed herein, based on the dock association data, the computing system may identify the two or more docks associated with the robot. For example, the computing system may parse the dock association data to identify the one or more dock identifiers of the two or more docks associated with the robot.

In some cases, the computing system may identify the two or more docks associated with the robot during navigation of an environment by the robot. For example, the computing system may identify the two or more docks during an initial recording of a mission by the robot. In another example, the computing system may identify the two or more docks during performance of a mission (e.g., during performance of a previously recorded mission).

In some cases, the computing system may identify the two or more docks in response to determining that the battery level of the battery of the robot does not satisfy a threshold, in response to an input from a user computing device (e.g., indicating to terminate recording of the mission), etc.

Based on identification of the two more docks, the computing system may identify a particular dock of the two or more docks. For example, the computing system may determine a respective distance between a location of the robot and a location of all or a portion of the two or more docks and may identify a dock of the two or more docks based on the distances (e.g., with a shortest distance as compared to the other distances between the location of the robot and the location of the other docks). In another example, the computing system may determine a respective time period associated with the two or more docks (e.g., a time period to navigate to a dock) and may identify a dock of the two or more docks based on the time periods (e.g., with a shortest time period as compared to the other time periods associated with the other docks). In another example, the computing system may determine a respective battery level of the battery of the robot associated with the two or more docks (e.g., a battery level of the battery based on navigation to a dock) and may identify a dock of the two or more docks based on the battery levels (e.g., with a highest battery level as compared to the other battery levels associated with navigation to the other docks). In another example, the computing system may determine a respective availability, maintenance status, and/or reliability associated with the two or more docks and may identify a dock of the two or more docks based on the availabilities, maintenance statuses, and/or reliabilities.

In some cases, the computing system may identify the two or more docks associated with the robot for generation of a mission. For example, based on the dock association data, the computing system may identify the two or more docks are eligible for inclusion in a mission associated with the robot. The computing system may identify the two or more docks and may instruct display of a user interface that indicates one or more route waypoints (e.g., including a route waypoint associated with a dock of the two or more docks), one or more route edges, one or more actions, etc. for generation of a mission. Based on an input (e.g., a selection of a route waypoint, a route edge, an action, etc.) received via the user interface, the computing system may dynamically generate a mission and may instruct navigation of the robot according to the mission.

In some cases, the computing system may identify one or more docks that are not associated with a particular robot. For example, the environment may include a set of docks and a first dock and a second dock of the set of docks may be associated with a first robot, a third dock of the set of docks may be associated with a second robot, a fourth dock, a fifth dock, and a sixth dock of the set of docks may be associated with a third robot, and a seventh dock and an eighth dock of the set of docks may not be associated with any particular robot. In some cases, the dock association data may indicate the one or more docks that are not associated with a particular robot. In some cases, the dock association data may indicate the one or more docks are associated with all or a portion of the robots of a fleet of robots. For example, the dock association may indicate a first dock and a second dock of the set of docks are exclusively associated with a robot (e.g., such that other robots are not eligible to dock at the first dock and the second dock) and a seventh dock and an eighth dock of the set of docks are non-exclusively associated with the robot (e.g., such that other robots are eligible to dock at the seventh dock and the eighth dock).

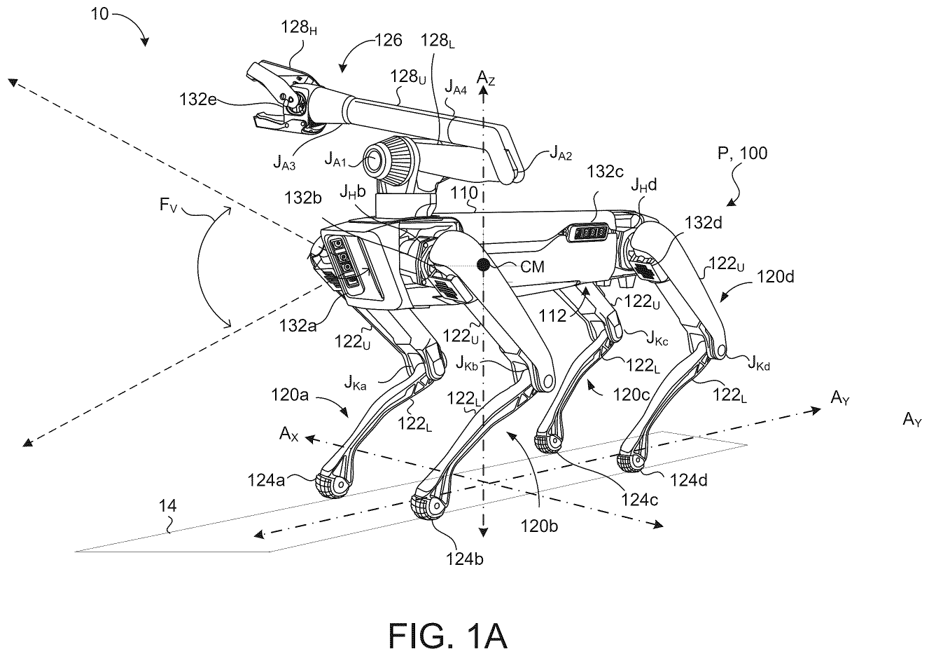

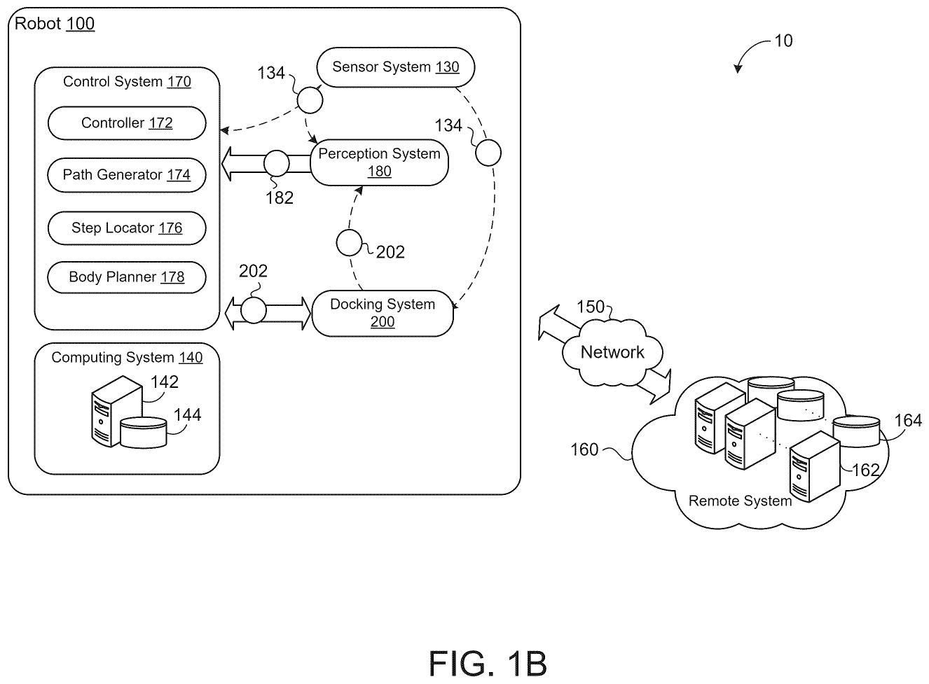

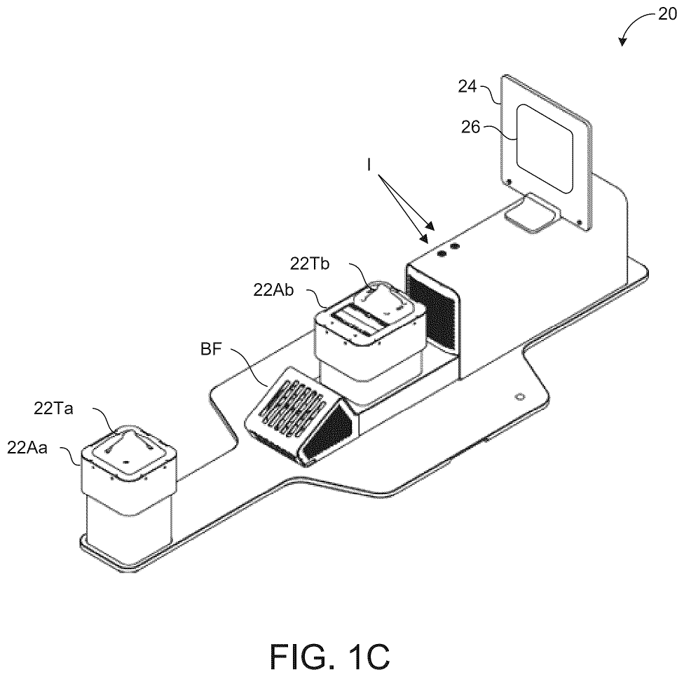

Referring to FIG. 1A, one embodiment of a robot 100 is depicted. The robot 100 includes a body 110 with one or more locomotion-based structures coupled to the body 110 that enable the robot 100 to move about the environment 10. In the example of FIG. 1A, the one or more locomotion-based structures include a front right leg 120a, a front left leg 120b, a rear right leg 120c, and a rear left leg 120d. In some examples, all or a portion of the front right leg 120a, the front left leg 120b, the rear right leg 120c, and the rear left leg 120d may be an articulable structure such that one or more joints J may permit members of the respective leg to move. For instance, all or a portion of the front right leg 120a, the front left leg 120b, the rear right leg 120c, and the rear left leg 120d may include a hip joint J_{H} coupling an upper member 122_{U} of the respective leg to the body 110 and a knee joint J_{K} coupling the upper member 122_{U} of the respective leg to a lower member 122_{L} of the respective leg. Although FIG. 1A depicts a quadruped robot with the front right leg 120a, the front left leg 120b, the rear right leg 120c, and the rear left leg 120d, the robot 100 may include any number of locomotion-based structures (e.g., a biped or humanoid robot with two legs, or other arrangements of one or more legs) that provide a means to traverse the terrain within the environment 10.

The body 110 includes one or more terminals 112 (e.g., one or more charging terminals). The one or more terminals 112 may be located on an underside of the body 110 of the robot 100 such that the one or more terminals 112 may face the ground plane 14 and may receive one or more complimentary terminals of a dock. In the example of FIG. 1A, the robot 100 includes a single terminal on a rear half portion of the body 110 of the robot 100 (e.g., towards the rear right leg 120c and the rear left leg 120d). In some implementations, the one or more terminals 112 on the underside of the body 110 may be centrally disposed along a longitudinal axis of the body 110 to ensure that when the one or more terminals 112 engage with one or more complimentary terminals of a dock, the robot 100 may be balanced. In some examples, the one or more terminals 112 may include a housing that serves as a female connector to matingly receive a complimentary male connector that is part of the housing of the terminal of the dock. For example, the terminal of the dock may protrude to some degree from the dock such that contact may be made between the one or more terminals 112 and the terminal of the dock (e.g., as the male connector of the dock seats or couples with the female connector of the robot 100). It will be understood that the dock and/or the robot 100 may include any number of terminals (e.g., two, three, or four terminals). For example, the robot 100 may include a pair of terminals such that a front half portion of the body 110 includes a first terminal and the rear half portion of the body 110 includes a second terminal.

In some examples, the one or more terminals 112 may be and/or may include a contact landing pad that the robot 100 may lower onto the terminal of the dock. In some cases, the robot 100 may charge via wireless or inductive charging. For instance, the robot 100 may charge using inductive charging where one or more designated portions of the robot 100 may be placed in inductive proximity with one or more specific portions of the dock.

In order to traverse the terrain, all or a portion of the front right leg 120a, the front left leg 120b, the rear right leg 120c, and the rear left leg 120d may have a distal end (e.g., a foot) that contacts a surface of the terrain (e.g., a traction surface, a ground surface, etc.). For example, the distal end of a leg may be the end of the leg used by the robot 100 to pivot, plant, or generally provide traction during movement of the robot 100. In some examples, though not shown, the distal end of a leg may include an ankle joint J_{A} such that the distal end may be articulable with respect to the lower member 122_{L} of the leg. In the example of FIG. 1A, the front right leg 120a has a distal end 124a, the front left leg 120b has a distal end 124b, the rear right leg 120c has a distal end 124c, and the rear left leg 120d has a distal end 124d.

In the examples shown, the robot 100 includes an arm 126 that functions as a robotic manipulator. The arm 126 may be configured to move about multiple degrees of freedom in order to engage elements of the environment 10 (e.g., objects within the environment 10). In some examples, the arm 126 may include one or more members, where the members may be coupled by joints J such that the arm 126 may pivot or rotate about the joint(s) J. For instance, with more than one member, the arm 126 may extend or retract. To illustrate an example, FIG. 1A depicts the arm 126 with three members (e.g., a lower member 128_{L}, an upper member 128_{U}, and a hand member 128_{H}). For example, the hand member 128_{H} may be an end-effector. The lower member 128_{L} may rotate or pivot about a first arm joint J_{A1} located adjacent to the body 110 (e.g., where the arm 126 connects to the body 110 of the robot 100). The lower member 128_{L} may be coupled to the upper member 128_{U} at a second arm joint J_{A2} and the upper member 128_{U} may be coupled to the hand member 128_{H} at a third arm joint J₃. In the example of FIG. 1A, the hand member 128_{H} may be a mechanical gripper that includes a one or more moveable jaws configured to perform different types of grasping of elements within the environment 10. Further, the hand member 128_{H} may include a fixed first jaw and a moveable second jaw that grasps objects by clamping the object between the jaws. The moveable jaw is configured to move relative to the fixed jaw in order to move between an open position for the gripper and a closed position for the gripper (e.g., closed around an object). In some implementations, the arm 126 may include a fourth joint J_{A4}. The fourth joint J_{A4} may be located near the coupling of the lower member 128_{L} to the upper member 128_{U} and may allow the upper member 128_{U} to twist or rotate relative to the lower member 128_{L}. For example, the fourth joint J_{A4} may function as a twist joint similarly to the third joint J_{A3} or wrist joint of the arm 126 adjacent the hand member 128_{H}. For instance, as a twist joint, one member coupled at the joint J may move or rotate relative to another member coupled at the joint J (e.g., a first member coupled at the twist joint is fixed while the second member coupled at the twist joint rotates). In some implementations, the arm 126 may connect to the robot 100 at a socket on the body 110 of the robot 100. In some configurations, the socket may be or may include a connector such that the arm 126 may attach or detach from the robot 100 depending on whether the arm 126 is desired for operation.

The robot 100 has a vertical gravitational axis (e.g., shown as a Z-direction axis A_{Z}) along a direction of gravity, and a center of mass CM, which is a position that corresponds to an average position of all parts of the robot 100 where the parts are weighted according to their masses (e.g., a point where the weighted relative position of the distributed mass of the robot 100 sums to zero). The robot 100 further has a pose P based on the CM relative to the vertical gravitational axis A_{Z} (e.g., the fixed reference frame with respect to gravity) to define a particular attitude or stance assumed by the robot 100. The attitude of the robot 100 can be defined by an orientation or an angular position of the robot 100 in space. Movement by all or a portion of the front right leg 120a, the front left leg 120b, the rear right leg 120c, and the rear left leg 120d relative to the body 110 may alter the pose P of the robot 100 (e.g., the combination of the position of the CM of the robot and the attitude or orientation of the robot 100). Here, a height generally refers to a distance along the z-direction (e.g., along a z-direction axis A_{Z}). The sagittal plane of the robot 100 corresponds to the Y-Z plane extending in directions of a y-direction axis A_{Y} and the z-direction axis A_{Z}. In other words, the sagittal plane bisects the robot 100 into a left and a right side. Generally perpendicular to the sagittal plane, a ground plane (also referred to as a transverse plane) spans the X-Y plane by extending in directions of the x-direction axis A_{X} and the y-direction axis A_{Y}. The ground plane may refer to a ground surface 14 where one or more distal ends of one or more legs of the robot 100 may generate traction to help the robot 100 move about the environment 10. Another anatomical plane of the robot 100 is the frontal plane that extends across the body 110 of the robot 100 (e.g., from a right side of the robot 100 with a front right leg 120a to a left side of the robot 100 with a front left leg 120b). The frontal plane spans the X-Z plane by extending in directions of the x-direction axis A_{X} and the z-direction axis A_{Z}.

In order to maneuver about the environment 10 or to perform tasks using the arm 126, the robot 100 includes a sensor system with one or more sensors. For instance, FIG. 1A illustrates a first sensor 132a mounted at a head of the robot 100, a second sensor 132b mounted near the hip of the front left leg 120b, a third sensor 132c mounted on a side of the body 110, a fourth sensor 132d mounted near the hip of the rear left leg 120d, and a fifth sensor 132e mounted at or near the hand member 128_{H}. The one or more sensors may include vision/image sensors, inertial sensors (e.g., an inertial measurement unit (EIU)), force sensors, and/or kinematic sensors. For example, the one or more sensors may include a camera such as a stereo camera, a time-of-flight (TOF) sensor, a scanning light-detection and ranging (LIDAR) sensor, or a scanning laser-detection and ranging (LADAR) sensor. In some examples, the one or more sensors may have a corresponding field(s) of view F_{V} defining a sensing range or region corresponding to the one or more sensors. For instance, FIG. 1A depicts a field of a view F_{V} for the robot 100. All or a portion of the one or more sensors may be pivotable and/or rotatable such that the sensor may, for example, change the field of view F_{V} about one or more axis (e.g., an x-axis, a y-axis, or a z-axis in relation to a ground plane).

When surveying a field of view F_{V} with a sensor, the sensor system may generate sensor data (also referred to as image data) corresponding to the field of view F_{V}. The sensor system may generate the sensor data with a sensor mounted on or near the body 110 (e.g., the first sensor 132a, the second sensor 132b, etc.). The sensor system may additionally and/or alternatively generate the sensor data with a sensor mounted at or near the hand member 128_{H} (e.g., the third sensor 132c). The one or more sensors may capture sensor data that defines a three-dimensional point cloud for the area within the environment 10 about the robot 100. In some examples, the sensor data may be image data that corresponds to a three-dimensional volumetric point cloud generated by a three-dimensional volumetric image sensor. Additionally or alternatively, when the robot 100 is maneuvering about the environment 10, the sensor system may gather pose data for the robot 100 that includes inertial measurement data (e.g., measured by an IMU). In some examples, the pose data includes kinematic data and/or orientation data about the robot 100, for instance, kinematic data and/or orientation data about joints J or other portions of a leg or arm of the robot 100. With the sensor data, various systems of the robot 100 may use the sensor data to define a current state of the robot 100 (e.g., of the kinematics of the robot 100) and/or a current state of the environment 10 about the robot 100.

In some implementations, the sensor system may include one or more sensors coupled to a joint J. The one or more sensors may couple to a motor M that operates a joint J of the robot 100 (e.g., the second sensor 132b, the third sensor 132c, the fourth sensor 132d, etc.). Here, the one or more sensors may generate joint dynamics in the form of joint-based sensor data. Joint dynamics collected as joint-based sensor data may include joint angles (e.g., an upper member 122_{U} relative to a lower member 122_{L} or hand member 126_{H} relative to another member of the arm 126 or robot 100), joint speed (e.g., joint angular velocity or joint angular acceleration), and/or forces experienced at a joint J (also referred to as joint forces). Joint-based sensor data generated by one or more sensors may be raw sensor data, data that is further processed to form different types of joint dynamics, or some combination of both. For instance, a sensor may measure joint position (or a position of member(s) coupled at a joint J) and systems of the robot 100 may perform further processing to derive velocity and/or acceleration from the positional data. In other examples, a sensor may measure velocity and/or acceleration directly.

Referring to FIG. 1B, the robot 100 may include a sensor system 130, a computing system 140, a control system 170, a perception system 180, and a docking system 200. As discussed herein, the sensor system 130 may obtain sensor data (e.g., via one or more sensors of the robot 100).

The computing system 140 may store, process, and/or communicate the sensor data 134 to various systems of the robot 100 (e.g., the control system 170, the perception system 180, and/or the docking system 200). In order to perform computing tasks related to the sensor data 134, the computing system 140 of the robot 100 may include data processing hardware 142 and memory hardware 144. The data processing hardware 142 may execute instructions stored in the memory hardware 144 to perform computing tasks related to activities (e.g., movement and/or movement based activities) for the robot 100. The computing system 140 may be and/or may include one or more locations of data processing hardware 142 and/or memory hardware 144.

In some examples, the computing system 140 may be a local system located on the robot 100. When located on the robot 100, the computing system 140 may be centralized (e.g., in a single location/area on the robot 100 such as a body of the robot 100), decentralized (e.g., located at various locations about the robot 100), or a hybrid combination of both (e.g., where a majority of centralized hardware and a minority of decentralized hardware). To illustrate some differences, a decentralized computing system may allow processing to occur at an activity location (e.g., at motor that moves a joint of a leg of the robot) while a centralized computing system may allow for a central processing hub that communicates to systems located at various positions on the robot 100 (e.g., communicate to the motor that moves the joint of a leg of the robot).

Additionally or alternatively, the computing system 140 may include computing resources that are located remotely from the robot 100. For instance, the computing system 140 may communicate via a network 150 with a remote system 160 (e.g., a remote server or a cloud-based environment). In some cases, the remote system 160 may include remote computing resources. In the example of FIG. 1B, the remote system 160 includes remote data processing hardware 162 and remote memory hardware 164. Sensor data 134 or other processed data (e.g., data processed locally by the computing system 140) may be stored in the remote system 160 and may be accessible to the computing system 140. In some cases, the computing system 140 may utilize the remote data processing hardware 162 and the remote memory hardware 164 as extensions of the data processing hardware 142 and the memory hardware 144 such that resources of the computing system 140 may reside on resources of the remote system 160.

The perception system 180 may receive the sensor data 134 from the sensor system 130 and may process the sensor data 134 to generate one or more maps 182. For example, the perception system 180 may help the robot 100 to move more precisely in a terrain with one or more obstacles. The perception system 180 may communicate all or a portion of the one or more maps 182 to the control system 170 in order to perform controlled actions for the robot 100, such as moving the robot 100 about the environment 10. In some examples, by having the perception system 180 separate from, yet in communication with the control system 170, processing for the control system 170 may focus on controlling the robot 100 while the processing for the perception system 180 focuses on interpreting the sensor data 134 gathered by the sensor system 130. For instance, the perception system 180 and the control system 170 may execute their processing in parallel to ensure accurate, fluid movement of the robot 100 in an environment 10.

In some cases, the perception system 180 may update and/or add data to the one or more maps 182 (e.g., by projecting sensor data 134 on a preexisting map) and/or to remove data from the one or more maps 182.

In some examples, the one or more maps 182 generated by the perception system 180 may be and/or may include a ground height map, a no step map, and/or a body obstacle map.

The perception system 180 may generate the ground height map based on spatial occupancy of an area (e.g., the environment 10) divided into three-dimensional volume units (e.g., voxels from a voxel map). In some implementations, the ground height map may indicate one or more heights at all or a portion of the X-Y locations within a grid of the ground height map (e.g., designated as a cell of the ground height map). For example, the ground height map may indicate, at a particular X-Y location in a horizontal plane, that the robot 100 should step at a certain height.

The no step map may indicate one or more regions where the robot 100 may not be allowed to step to advise the robot 100 whether the robot 100 may step at a particular horizontal location (e.g., a particular location in the X-Y plane). In some examples, the no step map may be partitioned into a grid of cells and all or a portion of the cells may represent a particular area in the environment 10 about the robot 100. For instance, all or a portion of the cells may be a three centimeter square. In some cases, all or a portion of the cells may be located within an X-Y plane within the environment 10. To generate the no-step map, the perception system 180 may generate a Boolean value map where the Boolean value map identifies one or more no step regions and/or one or more step regions. A no step region may refer to a region of one or more cells where one or more obstacles are perceived to exist while a step region may refer to a region of one or more cells where one or more obstacles are not perceived to exist. The perception system 180 may process the Boolean value map to determine a signed distance field indicating a distance to a boundary of an obstacle (e.g., a distance to a boundary of the no step region) and/or a vector v (e.g., defining a direction to the boundary of the no step region) to the boundary of an obstacle. In some cases, the no step map may include the distance and/or the vector v.

The body obstacle map (e.g., a map of obstacles for a body of the robot 100) may indicate one or more locations in the environment 10 where the body of the robot 100 may overlap a location of one or more obstacles in the X-Y plane with respect to the robot 100. For example, the body obstacle map may indicate one or more obstacles for the robot 100 to indicate whether the robot 100, by overlapping at a location in the environment 10, risks collision or potential damage with the one or more obstacles near or at the same location. One or more systems of the robot 100 (e.g., the control system 170) may use the body obstacle map to identify boundaries adjacent, or nearest to, the robot 100 as well as to identify directions (e.g., an optimal direction) to move the robot 100 in order to avoid an obstacle. In some examples, the body obstacle map may include and/or may be based on a grid of cells (e.g., a grid of the X-Y plane). All or a portion of the cells may include and/or may indicate a distance from an obstacle and a vector pointing to a cell that corresponds to an obstacle (e.g., a boundary of the obstacle).

The control system 170 may communicate with the sensor system 130 and any other system of the robot 100 (e.g., the perception system 180 and/or the docking system 200). The control system 170 may perform operations and other functions using the computing system 140.

In the example of FIG. 1B, the control system 170 includes a controller 172 (e.g., a programmable controller), a path generator 174, a step locator, and a body planner 178. In some cases, the control system 170 may include multiple controllers, path generator, step locators, body planners, etc.

The controller 172 may control the robot 100 by controlling movement about one or more joints J of the robot 100. In some configurations, the controller 172 may be and/or may correspond to software with programming logic that controls at least one joint J or a motor M which operates, or is coupled to, a joint J. For instance, the controller 172 may control an amount of force that is applied to a joint J (e.g., torque at a joint J). The number of joints J that the controller 172 controls may be scalable and/or customizable for a particular control purpose. The controller 172 may control a single joint J (e.g., control a torque at a single joint J), multiple joints J, or actuation of one or more members (e.g., actuation of a hand member) of the robot 100. By controlling one or more joints J, actuators or motors M, the controller 172 may coordinate movement for all or a portion of the different parts of the robot 100 (e.g., a body, one or more legs, an arm, etc.). For example, to perform some movements or tasks, the controller 172 may control movement of multiple parts of the robot 100 such as, for example, two legs, four legs, or two legs combined with the arm.

The controller 172 may control movement of the robot 100 to traverse about the environment 10 based on input or feedback from one or more systems of the robot 100 (e.g., the sensor system 130, the perception system 180, and/or the docking system 200). This may include movement between poses and/or behaviors of the robot 100. For example, the controller 172 may control different footstep patterns, leg patterns, body movement patterns, or vision system-sensing patterns.

In some cases, the control system 170 may include one or more specialty controllers that are dedicated to a particular control purpose. The one or more specialty controllers may include the path generator 174, the step locator 176, and/or the body planner 178.

The path generator 174 may determine horizontal motion for the robot 100. For instance, the horizontal motion may refer to translation (e.g., movement in the X-Y plane) and/or yaw (e.g., rotation about the Z-direction axis A_{Z}) of the robot 100. The path generator 174 may determine one or more obstacles within the environment 10 about the robot 100 based on the sensor data 134. The path generator 174 may communicate the identifier of the one or more obstacles to the step locator 176 such that the step locator 176 may identify foot placements for one or more legs of the robot 100 (e.g., locations to place one or more distal ends of one or more legs of the robot 100). The step locator 176 may generate the foot placements (e.g., locations for placement of one or more distal end of the robot 100) using inputs from the perception system 180 (e.g., the one or more maps 182). The body planner 178 may receive inputs from the perception system 180 (e.g., the one or more maps 182). The body planner 178 may adjust dynamics of the body of the robot 100 (e.g., rotation, such as pitch or yaw and/or height of COM) to successfully move about the environment 10.

FIG. 1C is an example of a dock 20 (e.g., a charging station, a docking station, etc.) for a robot. In the example of FIG. 1C, the dock 20 includes one or more features, a fiducial plate 24 for displaying a fiducial 26 associated with the dock 20, one or more indicators I that may indicate whether the robot is charging and/or powered-on, and a battery fan BF that may cool a battery of the robot docked on the dock 20. The dock 20 may be a source of power for the robot. For example, the dock 20 may power the robot such that the robot does not need a battery or expend power stored in a battery while the robot is connected to the dock 20. To perform a docking maneuver (e.g., to dock) on the dock 20, the robot may align charging terminals of the robot with the charging terminals of the dock 20 to receive electrical energy that charges the battery of the robot. In some cases, the dock 20 may include one or more terminals that may be and/or may include a communication link for transferring data between the robot and the dock 20 (e.g., sensor data, processed sensor data, etc.). In some cases, to perform a docking maneuver on the dock 20, the robot may reposition by moving one or more legs and/or a body of the robot while in or above some aspect of the dock 20.

The one or more features of the dock may include a front alignment tower 22Aa, a rear alignment tower 22Ab, a front charging terminal 22Ta, and a rear charging terminal 22Tb. In some cases, the front alignment tower 22Aa may include the front charging terminal 22Ta and/or the rear alignment tower 22Ab may include the rear charging terminal 22Tb. For example, the charging terminal may be located adjacent to an alignment feature of a corresponding alignment tower (e.g., a conical indexing structure). In some cases, the dock may include more, less, or different features, plates, indicators, fans, etc. For example, the dock 20 may include two alignment towers with a single charging terminal associated with one of the two alignment towers that can connect (e.g., electrically couple with the robot) at a rear portion of the robot (e.g., near the rear left leg and the rear right leg of the robot). In another example, the dock 20 may include any number of charging terminals.

The front charging terminal 22Ta and the rear charging terminal 22Tb may charge the battery of the robot. The front charging terminal 22Ta and the rear charging terminal 22Tb may include and/or may be an electrically conductive contact surface to charge the battery of the robot. In some cases, the front charging terminal 22Ta and/or the rear charging terminal 22Tb may couple with one or more complimentary charging terminals on the robot.

A top surface of the front alignment tower 22Aa and/or a top surface of the rear alignment tower 22Ab may protrude from the respective alignment tower in an alignment feature (e.g., a conical-like or pyramid-like structure for alignment purposes). In some cases, a charging terminal may be located at the alignment feature.

The robot may use the fiducial plate 24 as a point of reference (e.g., a local or global identifier of some spatial relationship). A fiducial 26 displayed via the fiducial plate 24 may be encoded with a data payload that includes information relevant to the operation of the robot and/or information about the point of reference that the fiducial 26 represents. For example, the payload of the fiducial 26 may identify information about the dock 20. As an example, a robot may be associated with or designated to a particular dock and the fiducial 26 may be encoded with information that identifies this relationship. The information may include a unique identifier for the dock 20 (e.g., a dock identifier) that is recognizable to the robot corresponding to the dock 20 (e.g., the robot shares the same identifier). In some examples, the sensor system and/or the perception system of the robot may use the fiducial 26 as a visual marker to establish a reference point within the environment about the robot (e.g., for localization of the robot). In some configurations, the fiducial 26 may be a visual marker used for localization by the robot. For example, the fiducial 26 may be and/or may include AprilTags or QR codes. The type of fiducial 26 may be based on a desired detection range for the fiducial 26 and/or the size of the payload encoded by the fiducial 26.

The structure of the dock 20 may pose a unique risk to a legged robot. For example, the dock 20 may include structures or features that the perception system of the robot may perceive as obstacles or regions where the robot should not step (e.g., no step regions). For example, if one or more legs of the robot collide or contact an alignment tower or the fiducial plate 24, the robot may trip and may damage the robot and/or the dock 20. As the robot may return to and perform a docking maneuver on the dock 20 to charge at a semi-frequent basis (e.g., once a day, multiple times a day, or several times a week), the chances that an alignment error occurs between the robot and the dock 20 may be increased.

Referring back to FIG. 1B, the docking system 200 may be a system of the robot 100 to perform a docking maneuver by the robot 100 at a dock. The docking system 200 may correct or modify one or more errors with respect to a dock. For example, the robot 100 may identify a pose of the dock based on the sensor data 134 and/or a pose of the robot 100. The identified pose of the dock may be inaccurate to a degree that may compromise the ability of the robot 100 to successfully perform a docking maneuver at the dock (e.g., as the dock may include one or more features that may demand precise alignment such as terminals). The docking system 200 may adjust (e.g., correct) the pose of the dock. For example, the docking system 200 may obtain the sensor data 134 (e.g., indicating a fiducial of the dock). The docking system 200 may determine a proximity and/or pose of the robot 100 (e.g., a position and orientation of the robot 100) and/or a pose of the dock based on a spatial relationship (e.g., a preconfigured or existing spatial relationship) between the fiducial and the dock. The docking system 200 may determine a spatial relationship between the robot and the dock (e.g., one or more features of the dock) based on the determined proximity and/or pose of the robot 100 and/or the determined pose of the dock.

The docking system 200 may receive the sensor data 134 and may generate, obtain, and/or identify dock data (e.g., environmental data associated with a dock) based on the sensor data 134. For example, the dock data may include sensor data (e.g., odometry data, point cloud data, etc.) associated with a dock. To generate the dock data, the docking system 200 may obtain the sensor data 134 and identify a portion of the sensor data 134 associated with the dock. One or more systems of the robot 100 may query the dock data to identify a dock and an area about the dock for performance of a docking maneuver.

When the robot 100 is docking (e.g., moving to the dock and assuming a docking pose that successfully couples one or more terminals of the robot 100 to one or more terminals of the dock) or de-docking (e.g., leaving an area of the dock starting from the docking pose), the control system 170 can utilize the dock data. For example, as the robot 100 moves in the vicinity of a dock (e.g., an area of the dock) represented in the dock data to perform the docking maneuver, the control system 170 may query the dock data to determine if a particular location associated with the dock is safe or not safe for the robot 100 to move into (e.g., with a body of the robot 100) or to step on (e.g., with a distal end of a leg of the robot 100).

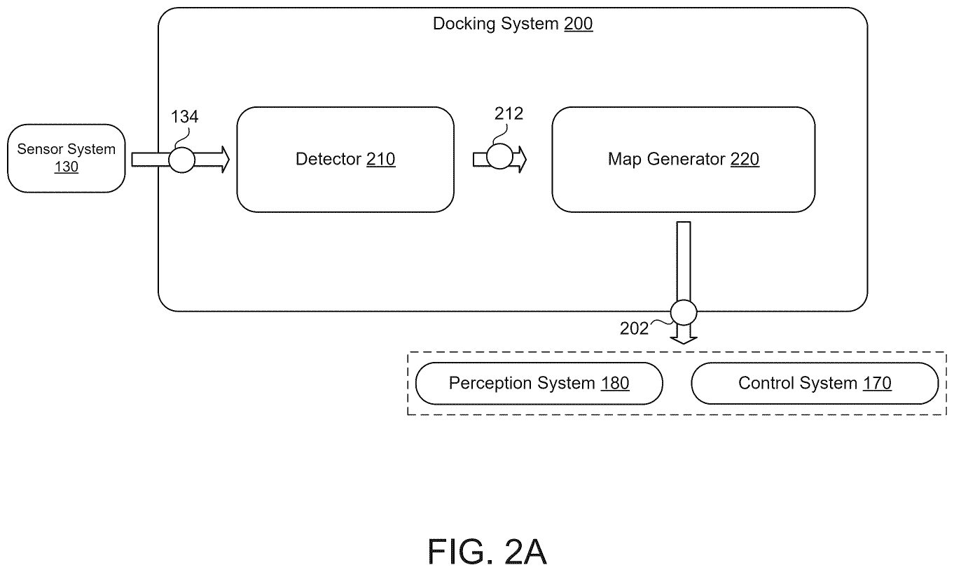

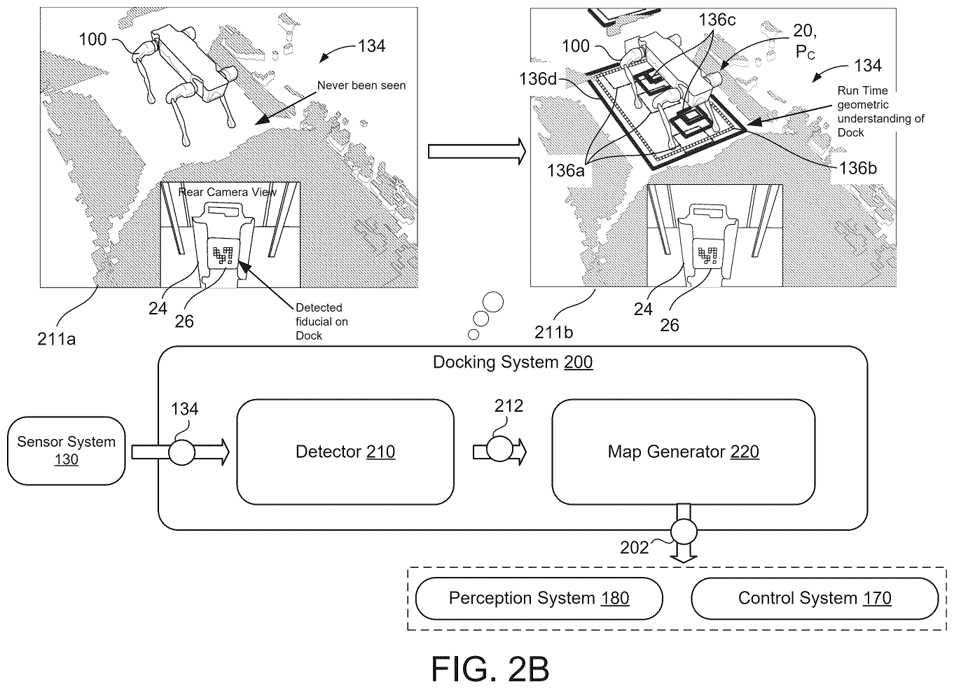

Referring to FIG. 2A, the docking system 200 includes a detector 210 and a map generator 220. The detector 210 may receive sensor data 134, from the sensor system 130, corresponding to an area of a dock. Based on the sensor data 134, the detector 210 may identify that the dock is present within the area being sensed by the robot. For example, the detector 210 identifies that the dock is present within the area by recognizing a fiducial adjacent to the dock. In some cases, the detector 210 may decode data encoded in the fiducial to identify that the dock corresponds to the robot. For example, the decoded data may include an identifier (e.g., a unique identifier) that indicates that the dock is associated with the robot. When the detector 210 identifies that the dock is present in the area about the robot, the detector 210 may identify a current pose P of the robot (e.g., relative to the dock) to understand a spatial relationship between the robot and the dock.

The detector 210 may use the sensor data 134 (e.g., perception sensor data processed by a perception system) to identify one or more features of the dock. Based on identifying one or more features of the dock, the detector 210 may determine whether the identified one or more features of the dock match data associated with the dock. For example, the docking system 200 may be programmed with data as to the geometry of the dock. The detector 210 may compare the identified one or more features based on the sensor data 134 to geometric features based on the data associated with the dock. When the comparison between the identified one or more features based on the sensor data 134 and the geometric features based on the data associated with the dock indicates a match or an approximate match (e.g., is within a threshold range of similarity), the detector 210 may route an identifier of features 212 (e.g., the identified one or more features based on the sensor data 134 and/or the geometric features based on the data associated with the dock) to a map generator 220 of the docking system 200.

In some examples, the docking system 200 may store data indicating one or more docks and/or respective geometries of the one or more docks. The detector 210 may generate a matching score based on comparing the identified one or more features based on the sensor data 134 and geometric features based on the data associated with the one or more docks. In some implementations, the detector 210 may use multiple features from the sensor data 134 and generate a matching score as an overall score as to how closely the multiple features match multiple geometric features of a dock. The detector 210 may generate a respective score for all or a portion of the one or more docks and determine that a particular dock with the highest score (e.g., as compared to the scores associated with the other docks) is the dock perceived via the sensor data 134.

The map generator 220 may receive the identifier of features 212 and/or identifier of a dock and may generate a map 202 of the environment. The map 202 may include and/or indicate one or more regions indicating terrain planning information similar to the regions or cells of the one or more maps 182. The map generator 220 may provide the map 202 to the perception system 180 and/or the control system 170.

FIG. 2B includes a representations of the environment 10 about the robot 100 to illustrate the map generation by the map generator 220. The representation includes a first image 211a and a second image 211b. The first image 211a portrays little to no terrain information in the vicinity of the robot 100 (e.g., shown as a white, non-shaded area). In contrast, the second image 211b shows one or more regions bounded by lines 136a, 136b, 136c, and 136d in the area of the robot 100. The lines 136a, 136b, 136c, and 136d may represent the data that the map generator 220 uses to generate the map 202. The area bounded by the lines 136a may represent one or more no step regions. The area bounded by the lines 136b may represent one or more step regions. The area bounded by the lines 136c may represent one or more terrain height regions (e.g., indicating one or more terminals of the dock). The area bounded by the lines 136d may represent one or more obstacles regions (e.g., indicating one or more obstacles that are at a collision height with a leg or a body of the robot 100).

In some cases, the docking system 200 may determine whether a dock has a valid status or an invalid status (e.g., based on the matching of the identified features to the geometric features). For example, the docking system 200 may generate the status based on the score. Further, the docking system 200 may generate the score based on whether another robot is on the dock, the detected dock is not a dock, etc. For example, if the docking system 200 determines a detected dock is not a dock or another robot is docked at the detected deck, the docking system 200 may mark the status of the dock as an invalid status. The robot 100 may not attempt to dock with a dock marked with an invalid status. If the docking system 200 marks the status of the dock as valid (e.g., based on the score satisfying a threshold), the robot 100 may proceed with performance of the docking maneuver at the dock. The map 202 may include an identifier of the dock. In some cases, the docking system 200 may determine a status of one or more docks and may indicate the determined status of the one or more docks in the map 202. The robot 100 may query the map 202 and determine whether the status of a dock is valid or invalid and determine whether to attempt to perform the docking maneuver at the dock.

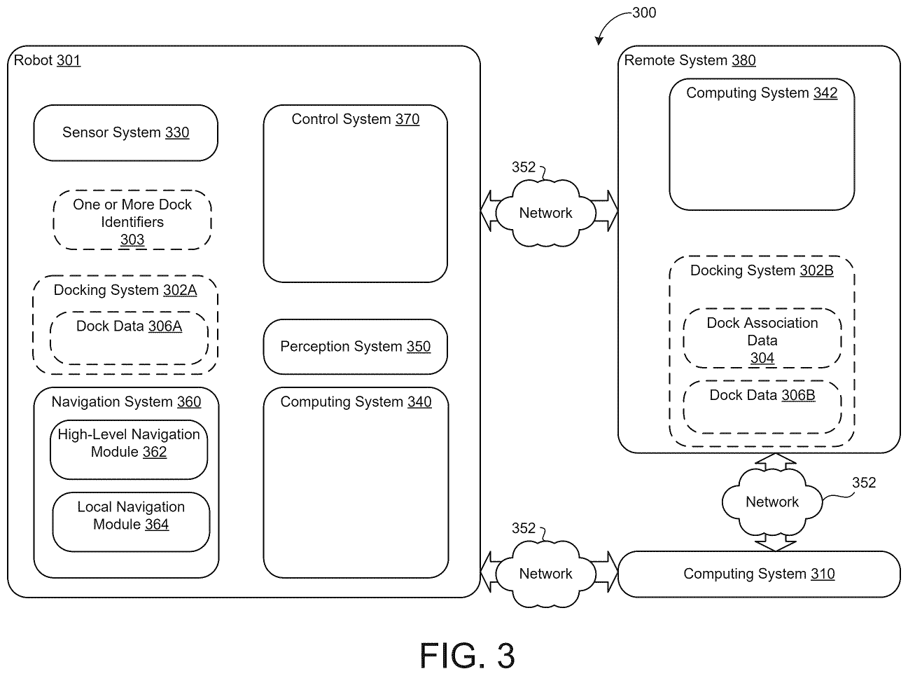

Referring now to FIG. 3, an environment 300 may include a robot 301 (the robot 301 may include and/or may be similar to the robot 100 discussed herein with reference to FIG. 1A, FIG. 1B, and FIG. 2B), a remote system 380 (the remote system 38 may include and/or may be similar to the remote system 160 discussed herein with reference to FIG. 1), and a computing system 310 (e.g., a remote controller, a user computing device, etc.). The robot 301, the computing system 310, and the remote system 380 may each be in communication (e.g., via the network 352 which may include and/or may be similar to the network 150 discussed herein with reference to FIG. 1B) with one another (e.g., the robot 301 may be in communication with the remote system 380). In some cases, the robot 301 may be in communication with multiple computing systems. For example, the robot 301 may be in communication with a plurality of user computing devices associated with a plurality of users. In some cases, a plurality of robots may be in communication with the computing system 310 and/or the remote system 380.

As discussed herein with reference to FIG. 1B, the robot 301 may include a sensor system 330, a computing system 340, a perception system 350, a navigation system 360, a docking system 302A, and a control system 370. For example, where the environment 300 includes a plurality of robots, all or a portion of the plurality of robots may include a respective sensor system, a respective control system, a respective perception system, a respective navigation system, a respective docking system, and/or a respective computing system.

As discussed herein, the sensor system 330 may include a plurality of sensors (e.g., image sensors) of the robot 301 and the sensor system 330 may gather the sensor data via the plurality of sensors. In one example, the sensor system 330 may include a plurality of sensors (e.g., five sensors) distributed on the robot 301. For example, the sensor system 330 may include a plurality of sensors distributed across the body, one or more legs, arm, etc. of the robot 301. The plurality of sensors may include at least two different types of sensors. For example, the plurality of sensors may include lidar sensors, image sensors, ladar sensors, audio sensors, etc.

The computing system 340 may include data processing hardware (e.g., a data processor, a hardware processor, etc.) and memory hardware. The memory hardware may store instructions and the data processing hardware may execute the instructions which may cause the data processing hardware to perform one or more operations.

The navigation system 360 may include one or more high-level navigation components and one or more local navigation components. In the example of FIG. 3, the navigation system 360 includes a high-level navigation module 362 and a local navigation module 364.

The robot 301 and/or the remote system 380 may further include a respective docking system. For example, as shown in FIG. 3, the robot 301 includes a docking system 302A and the remote system 380 includes a docking system 302B. In some cases, one or more of the robot 301 or the remote system 380 may not include a docking system. For example, the robot 301 may include the docking system 302A and the remote system 380 may not include the docking system 302B.

The docking system 302A and/or the docking system 302B may include a respective detector and/or a respective map generator (e.g., as discussed herein with reference to FIG. 2A and FIG. 2B).

In the example of FIG. 3, the robot 301 includes one or more dock identifiers 303 (e.g., indicative of one or more docks). In some cases, the one or more dock identifiers 303 may be stored in a data store (e.g., in a data store of a mission execution system of the robot 301). The one or more dock identifiers 303 may include and/or may indicate one or more docks (e.g., a list of docks) for the robot 301 (e.g., based on the dock association data 304). For example, the docking system 302B (or a separate system) may determine the one or more dock identifiers 303 based on the dock association data 304 and may route the one or more dock identifiers 303 to the robot 301. In some cases, the one or more dock identifiers 303 may be robot agnostic.

In the example of FIG. 3, the docking system 302A includes dock data 306A. Further, the docking system 302B includes dock association data 304 and dock data 306B. The navigation system 360 may utilize the one or more dock identifiers 303 to identify a dock for the robot 301, the docking system 302A may identify the dock within the environment based on the sensor data (e.g., indicating and/or identifying a fiducial of the dock) and the one or more dock identifiers 303, and the control system 370 may instruct performance of a docking maneuver relative to the identified dock using the dock data 306A and 306B.

The control system 370 may include a controller, a path generator, a step locator, and/or a body planner (e.g., as discussed herein with reference to FIG. 1). As discussed herein, the control system 370 may control the robot 301 (e.g., may instruct traversal of the robot 301 through an environment).

The remote system 380 may include a computing system 342. The computing system 342 may include data processing hardware and/or memory hardware.

The sensor system 330 can gather sensor data (e.g., via a plurality of sensors of the sensor system 330). For example, the sensor data may include lidar sensor data, image (e.g., camera) sensor data, radar sensor data, ladar sensor data, audio data, etc. The sensor system 330 may provide the sensor data to other systems of the robot 301 (e.g., the control system 370, the docking system 302A, the navigation system 360, etc.).

In some cases, the sensor data may include three-dimensional point cloud data. The sensor system 330 (or a separate system) may use the three-dimensional point cloud data to detect and track features within a three-dimensional coordinate system. For example, the sensor system 330 may use the three-dimensional point cloud data to detect and track movers within the environment.

In some cases, the sensor data may include panoramic image data. For example, the sensor data may include a 360 degree representation of the environment. In some cases, the sensor system 330 may automatically and/or continuously obtain (e.g., collect) sensor data. For example, the sensor system 330 may automatically and/or continuously obtain sensor data as the robot 301 navigates within the environment.

The perception system 350 may receive the sensor data from the sensor system 330 and may process the sensor data to generate map data (e.g., high-level navigation data representative of locations of static obstacles in an area the robot 301 is to navigate) of the environment 300. The map data may include and/or may indicate one or more maps. For example, the map data (e.g., one or more perception maps) may include a ground height map, a no step map, and/or a body obstacle map. In some cases, the map data may include predefined map data and/or live map data.

The ground height map may indicate for and/or include within each X-Y location within a grid of the map (e.g., designated as a cell of the ground height map) a particular height. The no step map may define regions where the robot 100 should not (e.g., is not allowed to) step (e.g., based on one or more obstacles, structures, objects, and/or entities). For example, the no step map may indicate one or more “no step” regions and one or more “step” regions. A no step region may be a region of one or more cells where an obstacle is perceived to exist while a step region may be a region of one or more cells where an obstacle is not perceived to exist. The body obstacle map (e.g., a map of obstacles for the body of the robot 100) may define areas where the body of the robot 100 may overlap with an obstacle, entity, structure, and/or object.

The perception system 350 may communicate the map data to the control system 370, the navigation system 360, etc. The control system 370 may use the map data to instruct the robot 301 to perform controlled actions (e.g., moving within the environment 300). In some cases, the navigation system 360 may be separate from, yet in communication with, the control system 370, such that the control system 370 controls the robot 301 while the navigation system 360 interprets the sensor data gathered by the sensor system 330. In some cases, the control system 370 and the navigation system 360 may execute in parallel to ensure accurate, fluid movement of the robot 301 in an environment 300.

The navigation system 360 may receive the map data (e.g., from the perception system 350). In some cases, the map data may include a graph map (e.g., a topological map). In some cases, the high-level navigation module 362 may generate the map data (e.g., a graph map). The high-level navigation module 362 can obtain (e.g., from the remote system 380, a remote controller, a topology component, etc.) and/or generate a series of route waypoints on the graph map for a navigation route that may plot a path around one or more obstacles from a start location (e.g., the current location of the robot 301) to a destination location. Route edges may connect two route waypoints of the series of route waypoints. In some cases, a route edge may indicate one or more geometric transforms between two route waypoints based on odometry data (e.g., odometry data from motion sensors or image sensors to determine a change in the robot's position over time). Two or more route waypoints and one or more route edges may be representative of a navigation route for the robot 301 to follow from a start location to a destination location. In some cases, the high-level navigation module 362 may generate mission data (e.g., indicative of the navigation route).

The local navigation module 364 may receive the mission data (e.g., the navigation route). In some cases, the local navigation module 364 may receive an obstacle map (e.g., a local obstacle map, an obstacle grid map, etc.) based on sensor data (e.g., image data) from the sensor system 330. In some cases, the local navigation module 364, using the sensor data, may generate the obstacle map. The obstacle map may be a robot-centered map that maps obstacles (e.g., static and/or dynamic obstacles) in the vicinity (e.g., satisfies a threshold) of the robot 301 based on the sensor data. For example, while the graph map may include data relating to the locations of walls of a hallway, the obstacle map (e.g., as generated using the sensor data obtained as the robot 301 traverses the environment 300) may include data regarding dynamic obstacles (e.g., a stack of boxes placed in the hallway that were not present during the original recording).

The local navigation module 364 can generate a step plan (e.g., using an A* search algorithm) that plots all or a portion of the individual steps (or other movements) of the robot 301 to navigate from the current location of the robot 301 to the next route waypoint of the navigation route. For example, the local navigation module 364 may generate the step plan using the obstacle map and the mission data. Using the step plan, the robot 301 can maneuver through the environment 300.

The docking systems 302A and 302B may obtain the sensor data (e.g., from the sensor system 330). In some cases, the docking systems 302A and 302B may obtain dock data 306A and 306B based on the sensor data. In some cases, the docking systems 302A and 302B may generate the dock data 306A and 306B based on the sensor data. As discussed herein, the dock data 306A and 306B may indicate and/or identify a dock and an area of the dock for performance of the docking maneuver. In some cases, the dock data 306A and 306B may indicate one or more obstacles (e.g., one or more obstacles associated with the dock). In some cases, the mission data may include the dock data 306A and 306B.

A system (e.g., a mission system, a mission execution system) of the robot 301 (not shown in FIG. 3) may determine to instruct performance of a docking maneuver by the robot 301 at a dock based on the mission data and may instruct performance of the docking maneuver. For example, the mission system may determine to dock the robot 301 at the dock based on determining that a battery level (e.g., a charge percentage of a battery of the robot 301) does not satisfy a threshold. In another example, the mission system may determine to dock the robot 301 at the dock based on determining that the robot 301 did not perform (e.g., was unable to perform) a mission, did not perform an action, did not navigate via a route edge, did not navigate to a route waypoint, etc. In another example, the mission system may determine to dock the robot 301 at the dock based on determining that the robot 301 performed all or a portion of the actions associated with a mission, navigated to all or a portion of the route waypoints associated with the mission, navigated via all or a portion of the route edges associated with the mission, etc.

Based on determining to dock the robot, the system may provide instructions to navigate to and dock the robot 301 at the dock (e.g., to the navigation system 360). Based on the instructions and the one or more dock identifiers 303, the navigation system 360 may identify a dock from one or more docks indicated by the one or more dock identifiers (e.g., a dock of the one or more docks that is closest to the robot 301) and may identify a route to the dock. The system may instruct navigation to the dock using the route and the navigation system 360 may provide (e.g., iteratively) instructions to navigate a portion of the route to the control system 370. Based on determining that navigation of the portion of the route is completed, the navigation system 360 may provide a next portion of the route. Based on navigation of the route, the control system 370 may instruct performance of the docking maneuver.

In some cases, the robot 301 (e.g., a mission execution system of the robot 301) may store data (e.g., maneuver data based on an input received via a user interface) indicating whether the robot 301 may not dock, may dock (e.g., at a mission continuation dock), recharge, and reattempt to perform a mission, perform an action, navigate a route edge, navigate a route waypoint, etc., and/or may dock (e.g., at a mission termination dock) and terminate the mission. In some cases, the docking systems 302A and 302B may identify and/or may indicate a number of attempts for the robot to attempt before docking and terminating the mission (e.g., based on an input received via a user interface). The data may be robot agnostic data.

In some cases, the system may determine to perform a docking maneuver by the robot 301 at the dock based on the one or more dock identifiers 303 and/or the dock association data 304. The dock association data 304 may indicate two or more docks associated with the robot 301, a type of the two more docks relative to the robot 301 (e.g., mission continuation docks, mission termination docks, etc.), a route waypoint of the two more docks, etc. For example, the dock association data 304 may indicate that N docks are associated with the robot 301 where N may be any number. While the dock association data 304 may indicate docks and a robot may associated with the docks, the one or more dock identifiers 303 may indicate a list of docks (e.g., without an identification of a robot).

In some cases, the dock association data 304 and/or the one or more dock identifiers 303 may include one or more strings, one or more flags (e.g., one or more Boolean flags), one or more keywords, one or more identifiers, one or more field-value pairs, etc. For example, the dock association data 304 and/or the one or more dock identifiers 303 may include a “disable_recharge” flag indicating whether a robot can recharge and continue a mission at a particular dock and/or a “disable_end” flag indicating whether a robot can terminate a mission at a particular dock.

The docking system 302B may obtain the dock association data 304 from the computing system 310, from a data store, etc. In some cases, to determine to instruct performance of the docking maneuver by the robot 301 at the dock, the docking system 302B may identify the robot 301 is operating within an environment, identify the one or more dock identifiers 303 (e.g., of one or more docks) are associated with the environment and the robot based on the dock association data 304, and route the one or more dock identifiers 303 to the robot 301. A system of the robot 301 (e.g., the control system 370) may select a dock based on the one or more dock identifiers 303 and instruct the robot 301 to perform the docking maneuver at the selected dock.

In some cases, the docking system 302B may identify one or more docks in the environment 300 (e.g., based on an input from a computing system, based on traversal of the environment 300 by one or more robots) and may associate the one or more docks with one or more robots (e.g., one or more robots that traversed the environment, one or more robots that did not traverse the environment, etc.) to generate the dock association data 304.

In some cases, the system of the robot 301 may determine to instruct performance of the docking maneuver by the robot 301 at the dock based on an input (e.g., received via the computing system 310). For example, the computing system 310 may provide an input requesting that the robot 301 dock at a dock.

In some cases, the system may validate that the dock (e.g., selected based on the input) is associated with the robot 301 (e.g., using the one or more dock identifiers 303). In some cases, the system may validate the dock is not associated with another robot (e.g., using the one or more dock identifiers 303).

Based on determining to instruct performance of the docking maneuver by the robot 301 at the dock (e.g., and validating that the dock is associated with the robot 301), the system may instruct the robot 301 to perform the docking maneuver at the dock using the dock data 306A and 306B. For example, the system may cause the robot 301 to dock using the dock data 306A and 306B.

Based on instructing the robot 301 to perform the docking maneuver at the dock and/or based on determining that the robot 301 docked (e.g., successfully) at the dock, the system may obtain an identifier of the dock. For example, the system may determine that the robot 301 docked at the dock and may obtain an identifier of the dock at which the robot 301 docked. In some cases, the system may provide the identifier of the dock to a separate system (e.g., the navigation system 360) based on determining that the robot 301 docked at the dock and obtaining the identifier.

In some cases, the system may obtain an identifier of the dock (e.g., without instructing the robot 301 to perform a docking maneuver at the dock). For example, the system may obtain an identifier of the dock from the computing system 310 and a request to associate the dock with the robot 301 (e.g., within the dock association data 304).

A system (e.g., the docking system) may generate the dock association data 304 based on the identifier of the dock. In some cases, the system may update the dock association data 304 based on the identifier of the dock.

Based on determining that the robot 301 did not perform a docking maneuver (e.g., was unsuccessful in docking) at the dock, the system may obtain an identifier of the dock and provide the identifier to the navigation system 360. The navigation system 360 may update the one or more dock identifiers 303. For example, the navigation system 360 may determine that the robot 301 did not perform a docking maneuver at the dock based on performance of the docking maneuver being obstructed (e.g., based on the dock being occupied, based on a route edge to the dock being obstructed, etc.) and may update the one or more dock identifiers 303 to disassociate the dock and the robot 301, remove the dock, etc. In some cases, based on determining that the robot 301 did not perform the docking maneuver at the dock, the navigation system 360 (or a separate system such as the control system 370) may identify a second dock based on the one or more dock identifiers 303 and the system may instruct the robot 301 to dock at the second dock. Based on determining that the robot 301 did not perform the docking maneuver at a dock, the navigation system 360 may select (e.g., continuously, repeatedly, etc.) additional dock(s) based on the one or more dock identifiers 303 and may determine if the robot 301 is able to perform the docking maneuver at the selected dock.

In some cases, the perception system 350 may generate and/or update map data (e.g., the mission data indicating one or more route waypoints, one or more route edges, etc.) based on an obstacle map (e.g., a local obstacle map) indicating an obstacle. For example, a system of the robot 301 may determine that a route edge is obstructed (e.g., by an obstacle) and the perception system 350 may update the map data to indicate that the route edge is obstructed.

In some cases, a system of the robot 301 (e.g., the control system 370) may determine that the one or more dock identifiers 303 do not identify a dock for the robot 301. For example, the system may disassociate all or a portion of the docks previously associated with the robot 301 in the one or more dock identifiers 303. Based on determining the one or more dock identifiers 303 do not identify a dock for the robot 301, the system can reset the one or more dock identifiers 303 (e.g., by reassociating docks that were previously associated with the robot 301 and disassociated) and/or the map data (e.g., by updating the map data to indicate that all or a portion of the route edges of the map data are not obstructed).

The navigation system 360 (or a separate system of the robot) may generate mission data based on the one or more dock identifiers 303. The mission data may indicate one or more docks at which the robot 301 can dock during performance of the mission based on the one or more dock identifiers 303. For example, the mission data may indicate that the robot 301 can perform a docking maneuver at any of the one or more docks during performance of the mission.

In some cases, the navigation system 360 may generate and/or update the mission data based on recording navigation by the robot 301 and performance of a docking maneuver by the robot 301 at the dock. For example, the navigation system 360 may determine that the robot 301 docked at two docks during recording of a mission and may generate mission data indicating that the robot 301 can perform a docking maneuver at any of the two docks during subsequent performance of the mission.

In some cases, the navigation system 360 may generate and/or update the mission data based on the determination that a route edge is obstructed. For example, the navigation system 360 may determine that a route edge is obstructed by an obstacle (e.g., that a door is closed and the robot is unable to opened the door), may identify one or more route edges, route waypoints, actions, etc. associated with traversal of the route edge (e.g., one or more route edges, route waypoints, actions, etc. that are based on traversing through a doorway of the door), and may remove the identified one or more route edges, route waypoints, actions, etc. (e.g., five route waypoints) from the mission and may update the mission such that the identified one or more route edges, route waypoints, actions, etc. are skipped by the robot 301 during performance of the updated mission.

In some cases, the computing system 340 (or a separate system of the robot) may provide a prompt to the computing system 310 to move the obstacle, provide alternative instructions, etc. and based on not receiving an input within a particular time period (e.g., one minute), may identify one or more route edges, route waypoints, actions, etc. associated with traversal of the route edge, and may remove the identified one or more route edges, route waypoints, actions, etc. from the mission. In some cases, the navigation system 360 may determine that the robot 301 has not traversed a particular route edge within a particular time period (e.g., one minute), may identify one or more route edges, route waypoints, actions, etc. associated with traversal of the route edge, and may remove the identified one or more route edges, route waypoints, actions, etc. from the mission. Upon termination of the mission, the navigation system 360 may reset the mission such that the mission includes the removed route edges, route waypoints, actions, etc.

In some cases, the navigation system 360 may store the generated and/or updated mission data. The navigation system 360 may use the generated and/or updated mission data (e.g., indicative of one or more obstructed route edges) to generate route waypoints, route edges, a step plan, etc.

In some cases, the computing system 340 may instruct display of the dock association data 304 and/or the one or more dock identifiers 303 (e.g., and identifiers of one or more route waypoints, route edges, actions, etc.) via a user interface of the computing system 310. The computing system 340 may obtain an input from the computing system 310. For example, the input may include a selection of one or more docks (e.g., a selection of one or more docks from the one or more docks assigned to the robot 301 based on the dock association data 304), one or more route waypoints, one or more route edges, one or more actions, etc. The navigation system 360 (or a separate system of the robot 301) may generate the mission data based on the input.

The control system 370 (or a separate system of the robot 301) may instruct navigation of the robot 301 according to the dock association data 304 and/or the one or more dock identifiers 303. For example, the control system 370 may instruct the robot 301 to navigate to a dock and perform a docking maneuver (e.g., during performance of a mission).

In some cases, the control system 370 (or a separate system of the robot 301) may instruct navigation of the robot 301 according to the dock association data 304, the mission data, and/or the one or more dock identifiers 303. For example, the control system 370 may instruct the robot 301 to navigate according to the mission and, during performance of the mission, the navigate to a dock and perform a docking maneuver based on the one or more dock identifiers 303. In some cases, the control system 370 (or a separate system of the robot 301) may instruct navigation of the robot 301 according to the dock association data 304 and/or the one or more dock identifiers 303 (e.g., and separate form a mission).

To instruct the robot to navigate to the dock, the control system 370 may determine to perform a docking maneuver by the robot 301 and the navigation system 360 may select the dock. For example, as discussed herein, the control system 370 may determine to perform a docking maneuver by the robot 301 based on determining that a battery level of the robot does not satisfy a threshold, based on determining that the robot has navigated all or a portion of the route waypoints and/or route edges of a mission and the mission indicates that the mission is to be terminated at a dock of one or more docks, etc.

Based on determining to perform a docking maneuver by the robot, the navigation system 360 may select a dock from the two or more docks associated with the robot based on the one or more dock identifiers 303. In some cases, the navigation system 360 may select the dock from two or more docks based on the one or more dock identifiers 303 and/or the mission data. For example, the one or more dock identifiers 303 may indicate two or more docks associated with the robot and the mission data may indicate all or a portion of the two or more docks associated with the robot for performance of the mission and the navigation system 360 may select the dock from the all or a portion of the two or more docks associated with the robot for performance of the mission.

In some cases, the navigation system 360 may identify a docking maneuver for performance by the robot 301 and may filter the two or more docks (e.g., the two or more docks associated with the robot 301 based on the one or more dock identifiers 303). The docking maneuver may be based on the mission data, an input from the computing system 310, etc. (e.g., indicating an action to be performed by the robot). For example, the docking maneuver may be associated with mission continuation (e.g., the robot 301 is to dock and continue navigation, execution of a mission, etc.) or the docking maneuver may be associated with mission termination (e.g., the robot 301 is to dock at the dock and terminate a mission). Different docks may be eligible for mission termination and/or mission continuation by the robot. For example, the dock association data 304 and/or the one or more dock identifiers 303 may indicate that a first dock is assigned to the robot 301 as a mission continuation dock such that the robot 301 can continue a mission but may not terminate a mission at the first dock, a second dock is assigned to the robot 301 as a mission termination dock such that the robot 301 can continue and/or terminate a mission at the second dock, etc. The navigation system 360 may identify the docking maneuver and may filter the two or more docks to identify one or more docks at which the robot 301 is eligible to perform the docking maneuver based on one or more dock identifiers 303.

In some cases, a mission termination dock may also be a mission continuation dock in that a robot may recharge at a dock and terminate a mission or continue a mission. Further, a mission continuation dock may not also be a mission termination dock in that a robot may recharge at the dock and continue a mission but may not terminate a mission at the dock. In some cases, the dock association data 304 and/or the one or more dock identifiers 303 may not indicate whether a dock is associated with a robot as (e.g., may not different between) a mission continuation dock and a mission termination dock (e.g., the dock association data 304 and/or the one or more dock identifiers 303 may indicate that a dock is generally associated with a robot).

To select the dock from the two or more docks (e.g., or from the filtered one or more docks), the navigation system 360 may compare the two or more docks. For example, the navigation system 360 may compare a time period associated with (e.g., a time period to navigation to), a distance associated with (e.g., a distance to), a battery level associated with (e.g., a battery level of a battery of the robot 301 after navigation to the dock), a reliability associated with, a maintenance status associated with, an availability associated with, etc. all or a portion of the two or more docks. Based on comparing the two or more docks, the navigation system 360 may select a dock for performance of the docking maneuver by the robot. In some cases, the navigation system 360 may compare the two or more docks based on the generated and/or updated map data (e.g., mission data). For example, the generated and/or updated map data may indicate one or more obstructed route edge edges and the navigation system 360 may utilize the generated and/or updated map data to identify a time period, a distance, a battery level, a reliability, a maintenance status, an availability, etc. associated with a particular dock.

Based on selection of the dock, the computing system 340 may instruct the robot 301 to perform one or more docking maneuvers relative to the dock (e.g., based on the dock association data 304, the one or more dock identifiers 303, the dock data 306A and 306B, the sensor data, etc.). For example, the computing system 340 may instruct the robot 301 to navigate to the dock and to dock at the dock.

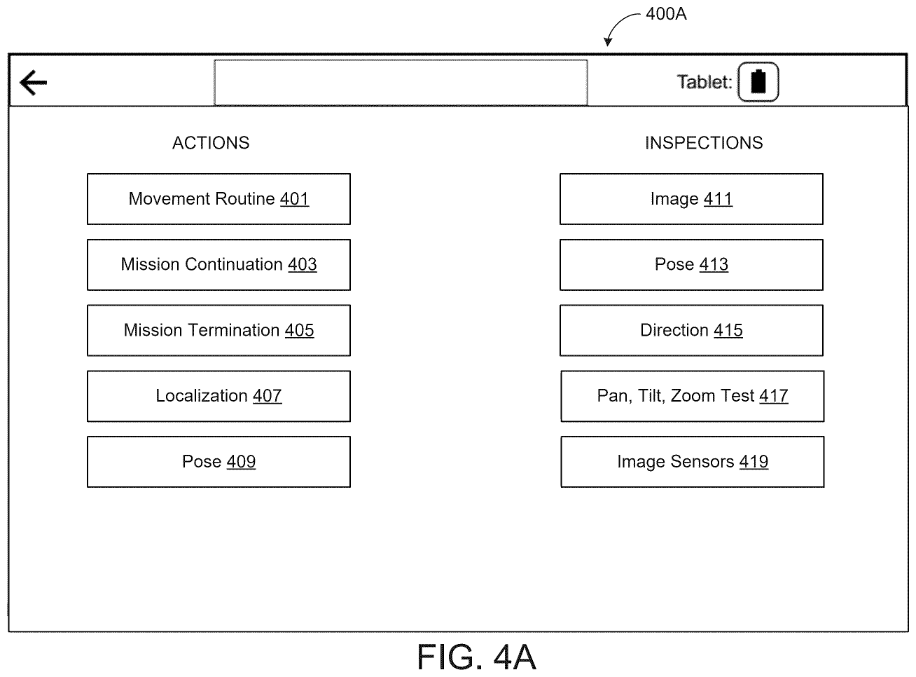

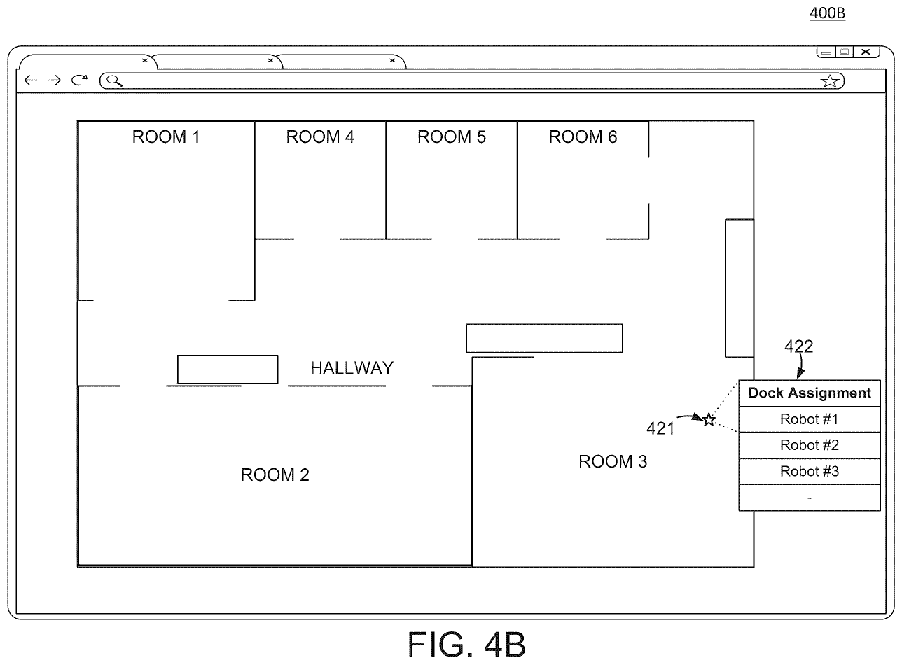

FIG. 4A is a schematic view of an example user interface 400A for associating a dock and a robot. The user interface 400A reflects identifiers for a set of commands for a robot. For example, a computing system may display the user interface 400A and, based on an input received via the user interface 400A (e.g., a selection of an identifier for a particular command), the computing system may route one or more commands to a robot (e.g., to perform a selected action and/or a selected inspection). In some cases, dock association data may be based on the input as discussed herein.

The set of commands may include one or more commands to perform one or more actions and/or one or more commands to perform one or more inspections. In the example of FIG. 4A, the user interface 400A indicates a movement routine action 401, a mission continuation 403, a mission termination 405, a localization action 407, a pose action 409, an image inspection 411, a pose inspection 413, a direction inspection 415, a pan, tilt, zoom test 417, and image sensor inspection 419.

The one or more actions and/or one or more commands may include a movement routine action 401 (e.g., an action to perform a movement routine), a mission continuation 403 (e.g., perform a docking maneuver at a dock, recharge, and continue recording of a mission), a mission termination 405 (e.g., perform a docking maneuver at a dock and terminate recording of a mission), a localization action 407 (e.g., an action to localize), a pose action 409 (e.g., an action to adjust a pose of the robot, verify a pose of the robot, etc.), etc. The one or more inspections may include an inspection relative to and/or with respect to an image inspection 411 of one or more images (e.g., all or a portion of the images associated with the robot, all or a portion of the images associated with a particular direction, etc.), a pose inspection 413 (e.g., a pose of a body of the robot), a direction inspection 415 (e.g., left of the robot), an image sensor inspection 419 of one or more image sensors of the robot (e.g., image sensors located on a front portion of the robot, image sensors located on a front portion of the robot in a black and white format, etc.), etc. In some cases, the one or more inspections may include a pan, tilt, zoom test 417.

In some cases, in response to a command to perform a mission termination and/or a mission continuation, a system of the robot (e.g., a docking system) can generate and/or update dock association data (e.g., can associate a dock with the robot). For example, in response to a command to perform a mission termination relative to a dock, the system can update the dock association data to associate the dock and the robot and add an identifier of the dock as a mission termination dock for the robot. In another example, in response to a command to perform a mission continuation relative to a dock, the system can update the dock association data to associate the dock and the robot and add an identifier of the dock as a mission continuation dock for the robot.

FIG. 4B is a schematic view of an example user interface 400B for associating a dock and a robot. The user interface 400B may reflect one or more route waypoints (e.g., corresponding to one or more docks in an environment) of the robot overlaid on a pictorial representation of the environment (e.g., indicating one or more rooms, hallways, obstacles, objects, entities, structures, etc.). A system of a robot (e.g., the computing system) may instruct display of the user interface 400B and, based on an input received via the user interface 400B (e.g., a selection of an identifier for a particular dock and/or route waypoint and an identifier of a particular robot), may generate and/or update dock association data as discussed herein.

In some cases, the user interface 400B may identify and/or may indicate one or more docks in the environment and a respective robot assigned to all or a portion of the one or more docks. For example, the user interface 400B may indicate that a first dock and a second dock are assigned to a first robot of the fleet of robots, a third dock is assigned to a second robot of the fleet of robots, and a fourth dock is not assigned to a robot of the fleet of robots (e.g., is a general dock, is not eligible for docking, is eligible for docking by all or a portion of the fleet of robots).

In some cases, the user interface 400B may identify and/or may indicate one or more docks eligible for assignment to one or more robots. For example, the user interface 400B may identify one or more docks for assignment to respective robots based on an input received via the user interface 400B.

In the example of FIG. 4B, the user interface 400B indicates a route waypoint 421 and an identifier 422 of a set of robots (including Robot #1, Robot #2, and Robot #3) for selection and assignment to the dock corresponding to the route waypoint 421. The user interface 400B further indicates that no robot may be selected for the dock (e.g., the dock may be designated as a general dock, a non-specific dock, a universal dock, etc.). The system may update and/or generate the dock association data based on selection of a robot or no robot for association with the dock.

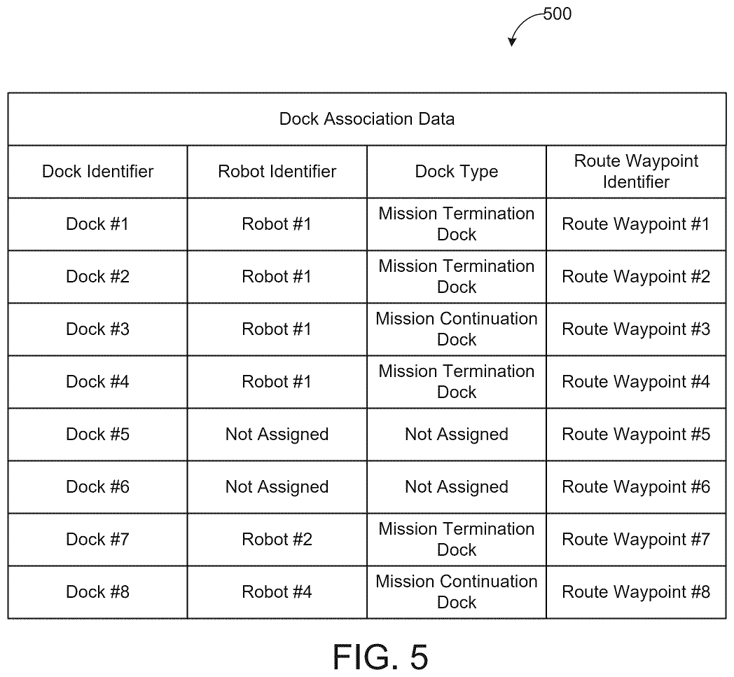

Based on association of a dock and a robot, a system can generate and/or update dock association data. FIG. 5 is a schematic view of one example of dock association data 500 (e.g., dynamic dock association data) based on association of a dock and a robot. The dock association data 500 may include data indicating an association between one or more docks and one or more robots. For example, the dock association data 500 may include one or more strings, flags, field-value pairs, keywords, identifiers, etc. In some cases, a system of a robot (e.g., a docking system) may generate and/or update the dock association data 500. In some cases, the system may instruct display of the dock association data 500 via a user interface.

In some cases, the dock association data 500 may include an identifier of a fiducial associated with the dock. For example, the dock association data 500 may include a payload of a fiducial associated with the dock.

In some cases, the dock association data 500 may be associated with a particular environment. For example, the dock association data 500 may indicate that the dock associations of the dock association data 500 are associated with Environment #123, Site ABC, etc.

In the example of FIG. 5, the dock association data 500 includes a dock identifier field, a robot identifier field, a dock type identifier, and a route waypoint identifier. Further, the dock association data 500 indicates that a dock identifier “Dock #1” with a route waypoint identifier “Route Waypoint #1” is associated with a robot identifier “Robot #1” as a dock type “Mission Termination Dock,” a dock identifier “Dock #2” with a route waypoint identifier “Route Waypoint #2” is associated with a robot identifier “Robot #1” as a dock type “Mission Termination Dock,” a dock identifier “Dock #3” with a route waypoint identifier “Route Waypoint #3” is associated with a robot identifier “Robot #1” as a dock type “Mission Continuation Dock,” a dock identifier “Dock #4” with a route waypoint identifier “Route Waypoint #4” is associated with a robot identifier “Robot #1” as a dock type “Mission Termination Dock,” a dock identifier “Dock #5” with a route waypoint identifier “Route Waypoint #5” is not assigned a robot or a dock type, a dock identifier “Dock #6” with a route waypoint identifier “Route Waypoint #6” is not assigned a robot or a dock type, a dock identifier “Dock #7” with a route waypoint identifier “Route Waypoint #7” is associated with a robot identifier “Robot #2” as a dock type “Mission Termination Dock,” and a dock identifier “Dock #8” with a route waypoint identifier “Route Waypoint #8” is associated with a robot identifier “Robot #4” as a dock type “Mission Continuation Dock.”

In some cases, the dock association data 500 may indicate a pose for the robot to perform a docking maneuver at a particular dock.

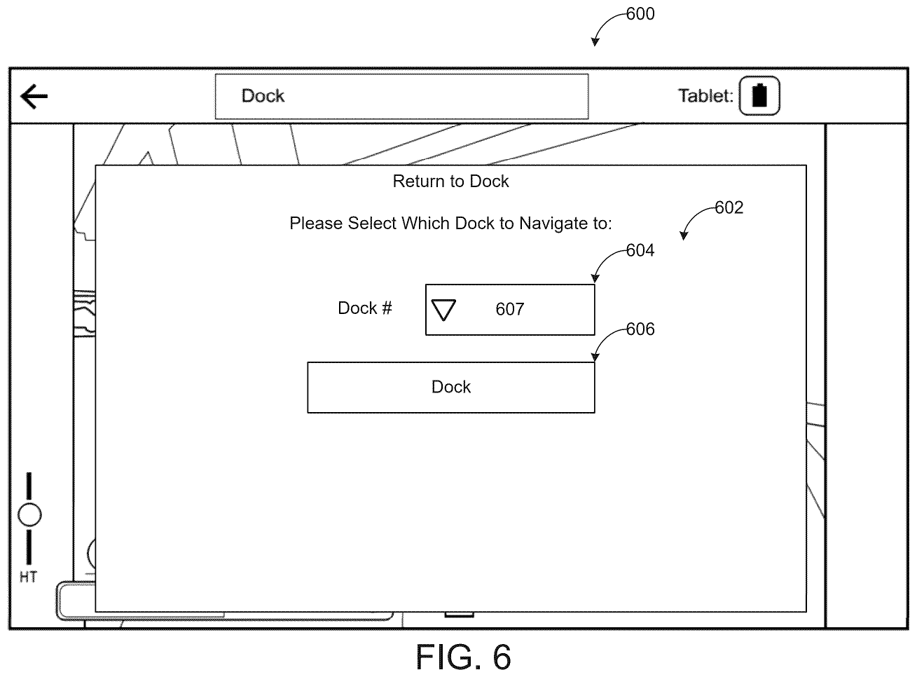

A system of the robot can instruct display of one or more identifiers of one or more docks associated with a robot based on the dock association data for selection of an identifier (e.g., selection of a dock). FIG. 6 is a schematic view of an example user interface 600 for selecting a dock associated with a robot. For example, the user interface 600 may identify one or more docks at which the robot is eligible to perform a docking maneuver and one or more docks at which the robot is not eligible (e.g., is ineligible) to perform a docking maneuver.

A system of the robot (e.g., the navigation system) may determine one or more docks at which the robot is eligible to perform a docking maneuver and/or one or more docks at which the robot is not eligible to perform a docking maneuver based on dock association data. For example, the system may identify a location of the robot (e.g., based on sensor data of the robot) and may determine dock association data associated with the location (e.g., associated with the environment of the robot). Based on the dock association data, the system may determine one or more dock identifiers of one or more docks associated with the robot for selection.

In some cases, the system may instruct display of the user interface 600 based on an input indicating a request to dock (e.g., an input indicating a request to perform a mission continuation or a mission termination). In some cases, the system may instruct display of the user interface 600 based on determining to instruct performance of the docking maneuver by the robot (e.g., based on determining that a battery level of a battery of the robot does not satisfy a threshold).

In the example of FIG. 6, the user interface 600 includes a first element 602, a second element 604, and a third element 606. The first element 602 may indicate a docking maneuver. In the example of FIG. 6, the first element 602 indicates a return to dock maneuver and requests selection of a dock. The second element 604 may indicate a set of docks for selection (e.g., based on the dock association data) and the third element 606 may indicate a dock command (e.g., “Dock”). For example, the system may instruct the robot to perform a docking maneuver relative to a dock selected based on the second element 604 based on an input received via the third element 606. In the example of FIG. 6, the second element 604 indicates a selection of Dock #607. The system may update and/or generate the dock association based on selection of a robot or no robot for association with the dock.

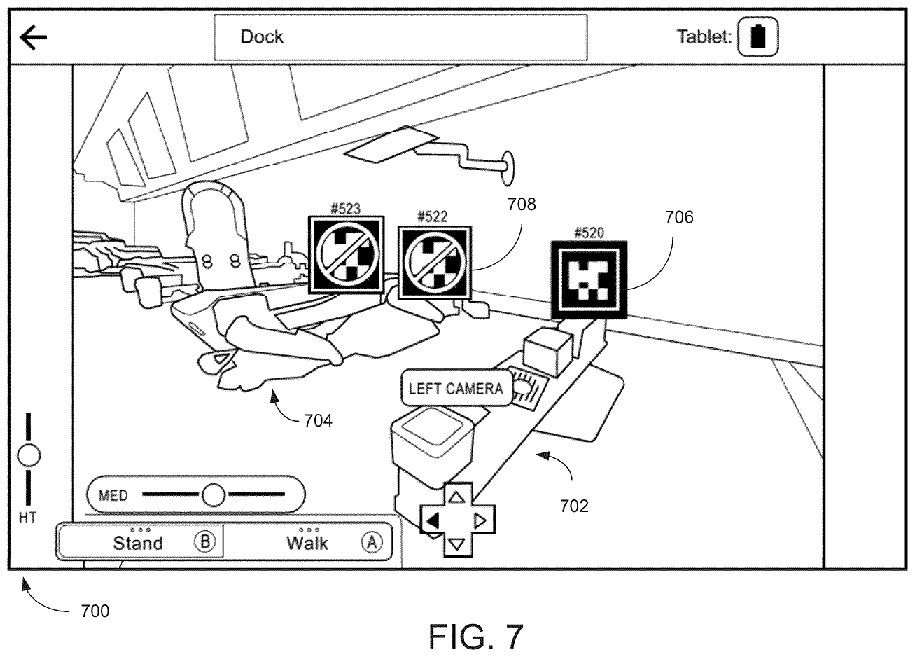

FIG. 7 is a schematic view of an example user interface 700 for selecting a dock associated with a robot. For example, the user interface 700 may identify, for a robot, one or more docks and may indicate whether the one or more docks are associated with the robot (e.g., eligible for performance of the docking maneuver by the robot) or are not associated with the robot (e.g., ineligible for performance of the docking maneuver by the robot) based on the dock association data.

A system of a robot may identify the one or more docks (e.g., based on sensor data associated with the robot). The system may identify an association status (e.g., an assignment status) of the one or more docks based on the dock association data. For example, the system may identify the one or more docks using sensor data, may identify the one or more docks within the dock association data, and may identify an association status of all or a portion of the one or more docks based on identifying the one or more docks within the dock association data (e.g., indicating whether the respective dock is assigned to a robot, and if so, which robot). The system may instruct display of the user interface 700 based on identifying the one or more docks and the association status of the one or more docks for selection of a dock associated with the robot.

In the example of FIG. 7, the user interface 700 indicates a first dock 702 (e.g., dock #520) associated with a first fiducial 706 and a second dock 704 (e.g., dock #522) associated with a second fiducial 708. Based on the dock association data, the user interface 700 indicates the first dock 702 is associated with the robot and the second dock 704 (and a third dock (e.g., dock #523)) are not associated with the robot such that the first dock 702 may be selected for performance of the docking maneuver by the robot. The system may instruct performance of the docking maneuver by the robot based on selection of a dock.

In some cases, the user interface 700 may indicate one or more docks that are not associated with the robot but are eligible for association with the robot (e.g., are not associated with another robot). Based on a selection of a dock of the one or more docks, the system may update and/or generate the dock association based on selection of a dock and/or may instruct performance of the docking maneuver by the robot.

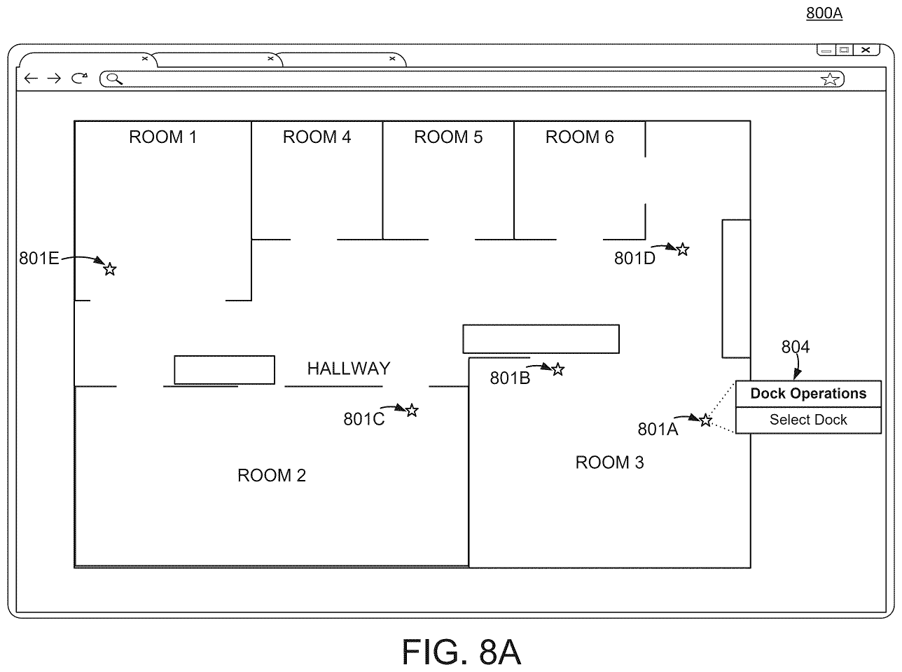

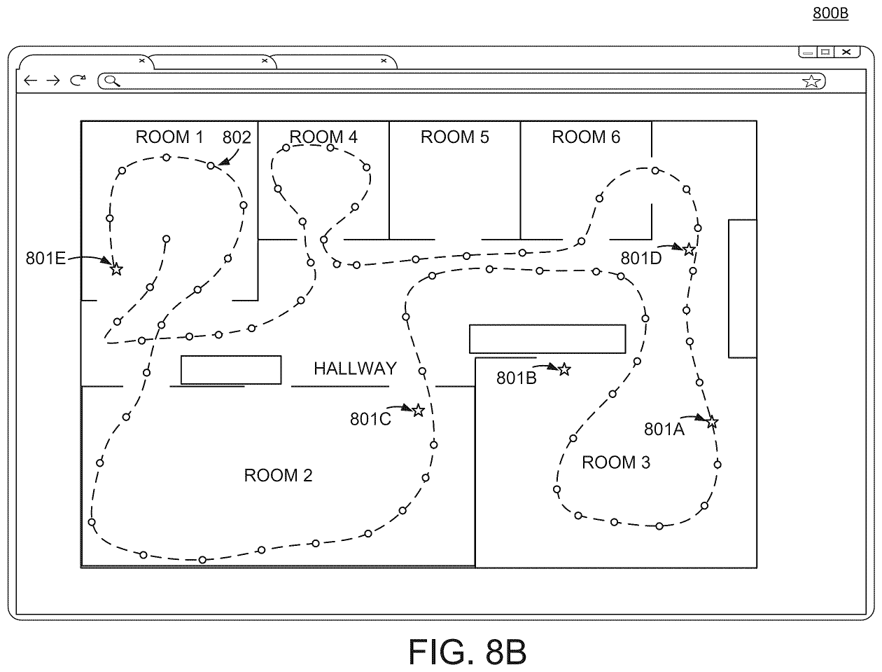

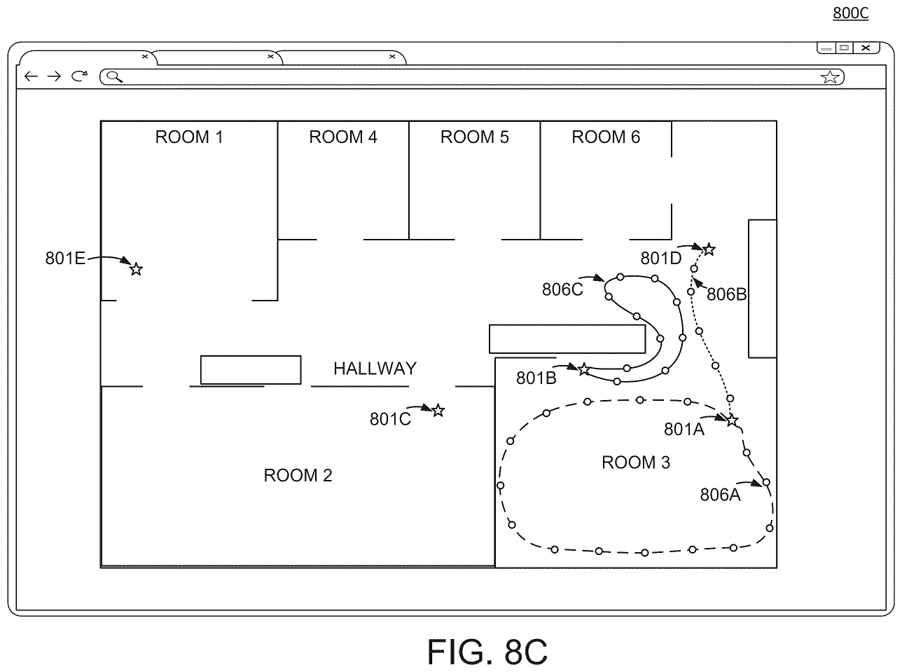

Based on the selection of one or more docks (e.g., from one or more docks associated with the robot), a system of the robot can instruct performance of the docking maneuver at a dock and/or generate a mission based on the dock. FIG. 8A is a schematic view of an example user interface 800A for generation of a mission. The user interface 800A may reflect one or more route waypoints associated with one or more docks associated with a robot based on dock association data. In the example of FIG. 8A, the user interface 800A reflects a first route waypoint 801A associated with a first dock, a second route waypoint 801B associated with a second dock, a third route waypoint 801C associated with a third dock, a fourth route waypoint 801D associated with a fourth dock, and a fifth route waypoint 801E associated with a fifth dock. A system of a robot (e.g., the computing system) may instruct display of the user interface 800A and, based on an input received via the user interface 800A, may generate and/or update a mission and/or may instruct performance of the docking maneuver at a dock.

The user interface 800A may reflect the one or more route waypoints within an environment of the robot overlaid on a pictorial representation of the environment. In the example of FIG. 8A, the user interface 800A reflects the first route waypoint 801A, the second route waypoint 801B, the third route waypoint 801C, the fourth route waypoint 801D, and the fifth route waypoint 801E overlaid on a representation of an environment that includes “Room 1,” “Room 2,” “Room 3,” “Room 4,” “Room 5,” “Room 6,” a “Hallway” and one or more obstacles, objects, structures, and/or entities. (e.g., indicating one or more rooms, hallways, obstacles, objects, entities, structures, etc.).

In some cases, the user interface 800A may identify one or more route waypoints corresponding to one or more docks associated with the robot and one or more route waypoints corresponding to one or more docks not associated with the robot. For example, the user interface 800A may indicate that one or more route waypoints corresponding to one or more docks associated with the robot are eligible for selection (e.g., for generation of a mission for the robot, for performance of a docking maneuver by the robot, etc.) and one or more route waypoints corresponding to one or more docks not associated with the robot are not eligible for selection.

In some cases, based on an interaction (e.g., a click, a hover, etc.) with an identifier of a route waypoint, the user interface 800A may provide an element for selection of the route waypoint and/or the associated dock.

In the example of FIG. 8A, the user interface 800A indicates interaction with an identifier of the first route waypoint 801A and indicates an element 804 (e.g., indicating one or more dock operations) for selection of the route waypoint and/or the dock. The system may instruct navigation and performance of the docking maneuver by the robot at the dock and/or generation of a mission based on a selection of the route waypoint and/or the dock.

FIG. 8B is a schematic view of an example user interface indicating a mission (e.g., a mission generated based on selection of a route waypoint and/or dock). The user interface 800B reflects a mission 802. The mission 802 may include one or more route waypoints (e.g., including one or more route waypoints corresponding to one or more docks), one or more route edges, one or more actions, etc.

A system of the robot (e.g., the computing system) may instruct display of the user interface via a computing system. In some cases, the system may define the mission 802 based on the traversal of the environment by one or more robots and the system may instruct display of the user interface via a computing system of the one or more robots.

In some cases, based on a selection of one or more route waypoints (e.g., corresponding to one or more docks) and a selection of a dock type associated with the one or more route waypoints, the system may define the mission 802 and one or more docks for the mission. For example, based on the selection of a first route waypoint corresponding to a first dock as a mission termination dock and the selection of a second route waypoint corresponding to a second dock as a mission continuation dock, the system may define the mission 802 that includes the first and second route waypoints.

In some cases, the system may include the selected route waypoints within the mission 802 such that a system (e.g., the system or a separate system) may dynamically determine how to navigate the robot. For example, a system may instruct navigation of a robot according to the mission 802. Based on a determination to instruct performance of a docking maneuver by the robot, the system may determine the docks associated with the mission 802 and a docking maneuver to be performed by the robot (e.g., a mission continuation, a mission termination, etc.). For example, the system may determine to instruct performance of a docking maneuver by the robot based on a determination that the robot has traversed all or a portion of the route waypoints and/or route edges of the mission 802 and the mission 802 indicates to end the mission 802 at a dock, the robot has performed all or a portion of the actions of the mission 802 and the mission 802 indicates to end the mission 802 at a dock, the robot has completed the mission 802 and the mission 802 indicates to perform the docking maneuver after completing the mission 802, the battery level of a battery of the robot does not satisfy the threshold, etc. Based on determination of the docks associated with the mission 802, the system may identify one or more of the docks that are associated with the mission 802 and that have a dock type corresponding to the docking maneuver (e.g., a mission continuation dock).

In the example of FIG. 8B, the user interface 800B indicates the mission 802 includes a first route waypoint 801A (e.g., corresponding to a first dock as a mission continuation dock) and a fifth route waypoint 801E (e.g., corresponding to a fifth dock as a mission termination dock). The system may instruct performance of the mission 802.

FIG. 8C is a schematic view of an example user interface indicating a set of missions. The user interface 800C reflects a first mission 806A, a second mission 806B, and a third mission 806C. The first mission 806A, the second mission 806B, and the third mission 806C may include one or more route waypoints (e.g., including one or more route waypoints corresponding to one or more docks), one or more route edges, one or more actions, etc.

A system of the robot (e.g., the computing system) may instruct display of the user interface via a computing system. In some cases, the system may define the first mission 806A, the second mission 806B, and/or the third mission 806C based on the traversal of the environment by one or more robots and the system may instruct display of the user interface via a computing system of the one or more robots.

In some cases, the first mission 806A, the second mission 806B, and/or the third mission 806C may be missions for the same or different robots. For example, the first mission 806A and the second mission 806B may be missions for a first robot (e.g., may be assigned to the first robot) and the third mission 806C may be a mission for a second robot.

In the example of FIG. 8C, the user interface 800C indicates the first mission 806A includes a first route waypoint 801A (e.g., corresponding to a first dock), the second mission 806B includes the first route waypoint 801A and a fourth route waypoint 801D (e.g., corresponding to a fourth dock), and the third mission 806C includes a second route waypoint 801B (e.g., corresponding to a second dock). The system may instruct performance of the first mission 806A, the second mission 806B, and/or the third mission 806C.

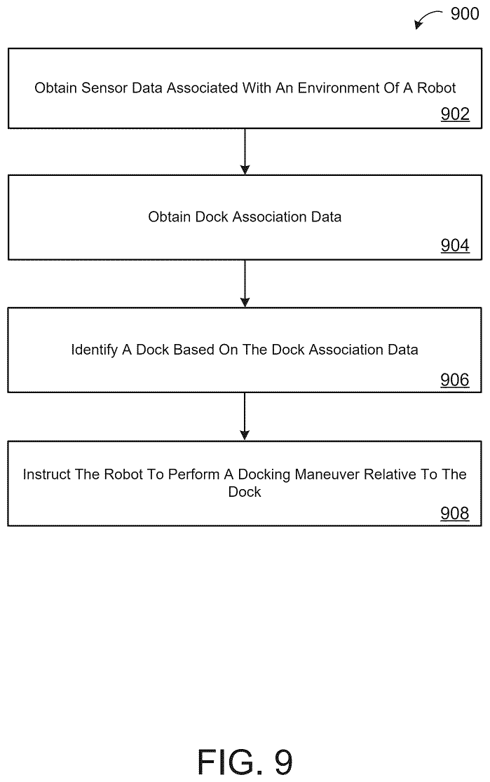

FIG. 9 shows a method 900 executed by a computing system that obtains sensor data and dock association data associated with a robot (e.g., a mobile robot, a legged mobile robot, a two-legged mobile robot, or a four-legged mobile robot), identifies a dock based on the dock association data, instructs performance of a docking maneuver by the robot, according to some examples of the disclosed technologies. The computing system may be similar, for example, to and/or may include the sensor system 330, the computing system 340, the perception system 350, the navigation system 360, the docking system 302A, and/or the control system 370, as discussed herein, and may include memory and/or data processing hardware. For example, the computing system may be located on and/or externally to the robot.

At block 902, the computing system obtains sensor data (e.g., first sensor data) associated with an environment of a robot (e.g., a legged robot).

In some cases, the robot may be a robot of a fleet of robots. Further, the environment may include a set of docks. For example, the environment may include two, four, six, etc. docks.

At block 904, the computing system obtains dock association data (e.g., associated with the robot). The dock association data may indicate an association of two or more docks to the robot. In some cases, the association may be an exclusive association of the two or more docks to the robot. In some cases, the dock association data may be based on the sensor data.

In some cases, the computing system may obtain the dock association data from a user computing device. In some cases, the computing system may identify an environment of the robot, may identify a set of docks associated with the environment (e.g., located in the environment), and may instruct display of a user interface indicating the set of docks via the user computing device (e.g., based on identifying the set of docks are associated with the environment). The computing system may obtain an input (e.g., indicating a selection of the two or more docks from the set of docks) via the user interface. In some cases, the computing system may transmit a request for an identifier of docks for the robot (e.g., an identifier of the two or more docks) and may obtain the dock association data based on the request. The computing system may obtain and/or generate the dock association data based on the input.

In some cases, the computing system may identify the two or more docks based on the sensor data and may generate the dock association data based on identifying the two or more docks.

In some cases, the computing system may obtain the dock association based on a docking maneuver (e.g., a second docking maneuver). For example, the computing system (or a separate system) may instruct performance of the docking maneuver by the robot (or a different robot) relative to a dock, may identify performance of the docking maneuver, and may generate the dock association data based on the performance of the docking maneuver. In another example, the computing system (or a separate system) may identify a request to perform the docking maneuver by the robot (or a different robot) relative to a dock (e.g., a request to perform a recharging action, a mission termination, etc.) and may generate the dock association data based on the request.

In some cases, the computing system may dynamically assign the two or more docks to the robot and may generate the dock association data based on dynamically assigning the two or more docks to the robot (e.g., all or a portion of the two or more docks may be assignable to any robot of a fleet of robots). In some cases, the computing system may obtain a dynamic association of the two or more docks to the robot and may generate the dock association data based on the dynamic association.

The dock association data may indicate one or more strings (e.g., indicting a dock), flags, field-value pairs, keywords, identifiers (e.g., an identifier of a dock, an identifier of a route waypoint associated with the dock, etc.), etc. For example, the dock association may indicate, for all or a portion of the two or more docks, an identifier of a route waypoint associated with the dock, an identifier of the dock, etc. In some cases, the dock association data may indicate one or more docking parameters (e.g., a pose for docking) and/or one or maps associated with all or a portion of the two or more docks.

In some cases, the dock association data may indicate an association of the two or more docks to the robot as particular dock types (e.g., mission continuation docks, mission termination docks, etc.). For example, the dock association may indicate an association of a subset (e.g., a first subset) of the two or more docks to the robot as mission continuation docks and an association of a subset (e.g., a second subset) of the two or more docks to the robot as mission termination docks.

The dock association data may indicate which docks of the two or more docks that the robot can (e.g., eligible to, is permitted to, etc.) perform different docking maneuvers. For example, the dock association data may indicate that the legged robot can perform a mission termination at the two or more docks and cannot a mission continuation at the two or more docks. In another example, the dock association data may indicate that the legged robot can perform a first docking maneuver at the two or more docks and cannot perform the first docking maneuver at a second dock in the environment.

In some cases, all or a portion of the robots of the fleet of robots may be associated with a respective subset of the set of docks according to dock association data (e.g., respective dock association data). In some cases, the dock association data may indicate an association of one or more docks with one or more robots.

At block 906, the computing system identifies a dock based on the dock association data. The computing system may identify a first dock of the two or more docks based on the dock association data. For example, the computing system may select the dock from the two or more docks. In some cases, the computing system may obtain one or more dock identifiers of one or more docks based on the dock association data (e.g., indicating one or more docks associated with the robot, associated with a fleet of robots including the robot, not associated with another robot, etc.) and may identify the dock based on the one or more dock identifiers.

In some cases, the computing system may identify the dock based on a time period, a distance, a battery level, a reliability, a maintenance status, an availability, etc. associated with all or portion of the two or more docks. For example, the computing system may identify a distance between a location associated with the robot and a respective location associated with all or a portion of the two or more docks. Further, the computing system may determine, for all or a portion of the two or more docks, a respective distance between the location associated with the robot and the location associated with the dock and may identify the dock based on determining the distances. In another example, the computing system may determine, for all or a portion of the two or more docks, a respective distance between the location associated with the robot and the location associated with the dock, may compare the respective distances, and may identify the dock based on comparing the distances.

In some cases, the computing system may obtain a map indicating a plurality of docks. For example, the map may indicate the two or more docks, a second dock (e.g., associated with a different robot such as a second legged robot), etc. The computing system may identify the dock based on the map.

In some cases, the computing system may instruct display of a user interface indicating the two or more docks (e.g., via a user computing device). For example, the user interface may include display of an identifier of a set of docks. The computing system may receive an input, from the user computing device, indicating a selection of the dock from the two or more docks and may identify the dock based on the selection.

In some cases, the computing system may obtain mission data (e.g., indicating and/or including one or more route waypoints, one or more route edges, one or more actions, etc.) associated with the robot and indicative of a mission associated with the robot. For example, the computing system may obtain a selection of one or more route waypoints, one or more route edges, one or more actions, etc. from a user computing device and may generate the mission data based on the selection. The computing system may identify the dock based on the mission data.

In some cases, based on sensor data, the computing system may identify an anomaly (e.g., that a route edge is obstructed, a dock is occupied by another robot, that the robot did not successfully perform a docking maneuver, etc.). For example, the computing system may identify an anomaly based on determining that the computing system instructed performance of a docking maneuver and the robot did not perform the docking maneuver, did not dock, etc. In some cases, the computing system may identify the dock based on identifying the anomaly. For example, the computing system may determine that a route edge of the one or more route edges is obstructed (e.g., by an obstacle) and may identify the dock based on determining that the route edge is obstructed. In some cases, based on identifying the anomaly, the computing system may identify one or more docks associated with the anomaly (e.g., one or more docks such that navigation by the robot to the one or more docks includes traversal of the obstructed route edge, one or more docks where access to the one or more docks is obstructed, one or more docks that are occupied by other robots, etc.) and may update and/or generate the one or more dock identifiers (e.g., to remove the one or more dock identifiers associated with the one or more docks, to disassociate the one or more docks from the robot, etc.). In some cases, based on identifying the anomaly, the computing system may identify one or more actions, route waypoints, and/or route edges associated with the anomaly (e.g., one or more route waypoints such that navigation by the robot to the one or more route waypoints includes traversal of the obstructed route edge) and may update and/or generate mission data (e.g., to remove the one or more actions, route waypoints, and/or route edges, generate different route waypoints and/or route edges, etc.).

In some cases, the computing system may identify that the one or more dock identifiers do not identify and/or indicate a dock associated with the robot (e.g., based on updating the one or more dock identifiers and/or the mission data). Based on identifying that the one or more dock identifiers do not identify and/or indicate a dock associated with the robot, the computing system may reset the one or more dock identifiers (e.g., reset the one or more dock identifiers to a prior version, obtain a previous version of the one or more dock identifiers, request the previous version of the one or more dock identifiers, etc.).

At block 908, the computing system instructs the robot to perform a docking maneuver (e.g., a first docking maneuver) relative to the dock (e.g., based on the sensor data and identifying the dock). For example, the computing system may instruct the robot to perform the docking maneuver relative to the dock based on selection of the dock.

The docking maneuver may be an autonomous docking maneuver. For example, the docking maneuver may be associated with mission termination and/or mission continuation.

To instruct the robot to perform the docking maneuver, the computing system may instruct the robot to dock, recharge, and traverse the environment (e.g., after recharging such that the battery level satisfies a threshold), to dock and terminate a mission, etc.

In some cases, the computing system may determine battery data associated with the robot (e.g., a battery level of a battery of the robot, a predicted battery level of the battery, etc.) and may instruct the robot to perform the docking maneuver based on the battery data (e.g., based on the battery level not satisfying a threshold).

In some cases, the computing system may obtain an instruction to perform the docking maneuver relative to the dock. The computing system may determine that the dock is associated with the robot based on the dock association data and/or the one or more dock identifiers and may instruct the robot perform the docking maneuver based on determining that the dock is associated with the robot. In some cases, the computing system may determine that the dock is obstructed (e.g., access to the dock is obstructed). The computing system may determine that a second dock is associated with the robot (e.g., based on the dock association data, the one or more dock identifiers, the mission data, etc.) and may instruct the robot to perform the docking maneuver relative to the second dock based on determining that the dock is obstructed and determining that the second dock is associated with the robot.

In some cases, the computing system may determine mission data (e.g., indicative of a mission) associated with the robot and may instruct the robot to perform the docking maneuver based on the mission data. For example, the computing system may instruct the robot to perform the docking maneuver based on performance of an action of the one or more actions. All or a portion of the one or more route edges may connect two respective route waypoints of the set of route waypoints.

In some cases, the mission data may indicate and/or may include one or more docks (e.g., one or more docks associated with the mission). For example, the mission data may indicate one or more docks at which a robot may dock during, after, and/or prior to performance of the mission. In some cases, the mission data may indicate and/or may include one or more route waypoints associated with the one or more docks.

In some cases, the computing system may update the mission data (e.g., by adding the dock to the mission data) based on identifying the dock (e.g., the mission data may indicate the one or more docks and the dock) and may instruct the robot to perform the docking maneuver based on the updated mission data. In some cases, the computing system may generate the mission data (e.g., indicating the dock, a set of route waypoints, one or more route edges, etc.) and may instruct the robot to perform the docking maneuver based on the mission data. In some cases, the computing system may generate the mission data (e.g., indicating two or more docks, a set of route waypoints, one or more route edges, etc.) and may instruct the robot to perform the docking maneuver based on the mission data.

In some cases, the mission data may indicate, for all or a portion of the docks of the mission data (e.g., the mission data), a dock type of the dock (e.g., whether the dock is a mission continuation dock or a mission termination dock). For example, the mission data may indicate that the dock is designated as a mission termination dock for the robot.

In some cases, the computing system may identify an anomaly associated with the mission data (e.g., an anomaly associated with performance of an action of the one or more actions, traversal of a route edge of the one or more route edges, etc.) and may instruct performance of the docking maneuver based on identifying the anomaly.

In some cases, the computing system may obtain sensor data (e.g., second sensor data), may generate a pictorial representation of the environment based on the sensor data, the one or more dock identifiers, and/or the dock association data, and may instruct display of the pictorial representation via a user computing device. The pictorial representation may indicate an association status of one or more docks (e.g., whether the one or more docks are associated with a robot, a robot associated with the dock, etc.). For example, the association status may indicate that a dock is assigned to the robot or a different robot.

In some cases, the computing system may instruct the robot to traverse the environment based on the mission data, the one or more dock identifiers, and/or the dock association data.

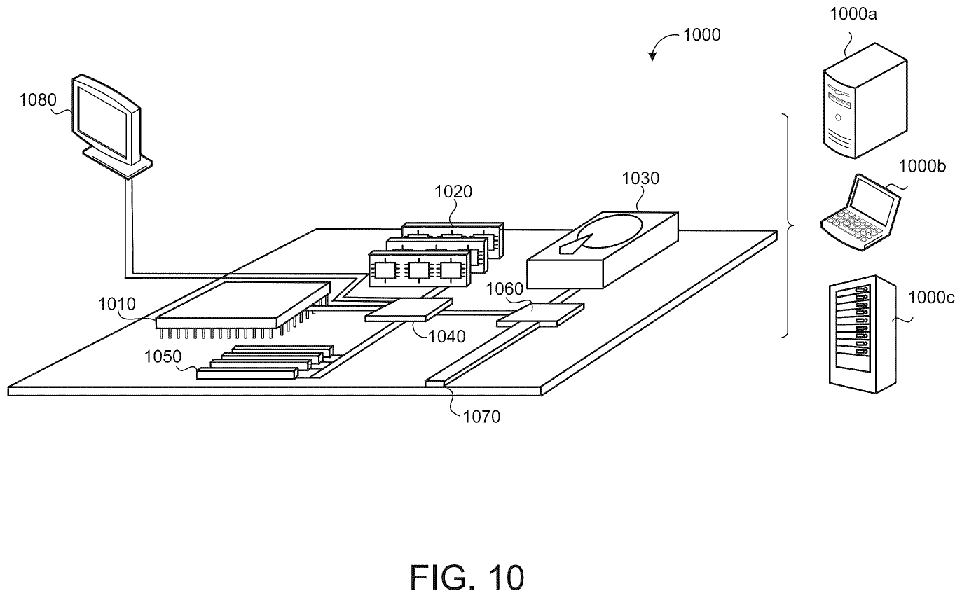

FIG. 10 is schematic view of an example computing device 1000 that may be used to implement the systems and methods described in this document. The computing device 1000 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 1000 includes a processor 1010 (e.g., data processing hardware 142, remote data processing hardware 162, etc.), memory 1020 (e.g., memory hardware 144, remote memory hardware 164, etc.), a storage device 1030, a high-speed interface/controller 1040 connecting to the memory 1020 and high-speed expansion port 1050, and a low-speed interface/controller 1060 connecting to a low-speed expansion port 1070 and a storage device 1030. All or a portion of the processor 1010, the memory 1020, the storage device 1030, the high-speed interface/controller 1040, the high-speed expansion port 1050, the low-speed interface/controller 1060, and/or the low-speed expansion port 1070 may be interconnected using various busses, and may be mounted on a common motherboard or in other manners as appropriate. The processor 1010 can process instructions for execution within the computing device 1000, including instructions stored in the memory 1020 or on the storage device 1030 to display graphical information for a graphical user interface (GUI) on an external input/output device, such as display 1080 coupled to high-speed interface/controller 1040. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 1020 (e.g., non-transitory memory) may store information non-transitorily within the computing device 1000. The memory 1020 may be a computer-readable medium, a volatile memory unit(s), or non-volatile memory unit(s). The memory 1020 may be physical devices used to store programs (e.g., sequences of instructions) or data (e.g., program state information) on a temporary or permanent basis for use by the computing device 1000. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 1030 is capable of providing mass storage for the computing device 1000. In some implementations, the storage device 1030 is a computer-readable medium. In various different implementations, the storage device 1030 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 1020, the storage device 1030, or memory on processor 1010.

The high-speed interface/controller 1040 manages bandwidth-intensive operations for the computing device 1000, while the low-speed interface/controller 1060 manages lower bandwidth-intensive operations. Such allocation of duties is exemplary only. In some implementations, the high-speed interface/controller 1040 is coupled to the memory 1020, the display 1080 (e.g., through a graphics processor or accelerator), and to the high-speed expansion ports 1050, which may accept various expansion cards (not shown). In some implementations, the low-speed interface/controller 1060 is coupled to the storage device 1030 and a low-speed expansion port 1070. The low-speed expansion port 1070, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 1000 may be implemented in a number of different forms, as shown in the figure. For example, it may be implemented as a standard server 1000a or multiple times in a group of such servers, as a laptop computer 1000b, or as part of a rack server system 1000c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media, and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A method comprising:
obtaining, by data processing hardware of a legged robot, first sensor data associated with an environment of the legged robot;
obtaining, by the data processing hardware, dock association data associated with the legged robot, wherein the dock association data indicates an association of two or more docks to the legged robot;
identifying, by the data processing hardware, a first dock of the two or more docks based on the dock association data; and
instructing, by the data processing hardware, the legged robot to perform a first docking maneuver relative to the first dock based on the first sensor data and identifying the first dock.

2. The method of claim 1, wherein a fleet of legged robots comprises the legged robot, wherein the environment of the legged robot comprises a set of docks, wherein each legged robot of the fleet of legged robots is associated with a respective subset of the set of docks according to respective dock association data for each legged robot.

3. The method of claim 1, wherein the dock association data further indicates that the legged robot is eligible to perform the first docking maneuver at the two or more docks, and wherein the dock association data further indicates that the legged robot is ineligible to perform the first docking maneuver at a second dock in the environment of the legged robot.

4. The method of claim 1, wherein the dock association data indicates docks at which the legged robot is permitted to perform the first docking maneuver.

5. The method of claim 1, wherein the dock association data further indicates a first association of a first subset of the two or more docks to the legged robot as mission continuation docks, and wherein the dock association data further indicates a second association of a second subset of the two or more docks to the legged robot as mission termination docks.

6. The method of claim 1, wherein the dock association data further indicates, for each respective dock of the two or more docks, one or more docking parameters associated with the respective dock.

7. The method of claim 1, further comprising:
determining, for each respective dock of the two or more docks, a distance between a location associated with the legged robot and a location associated with the respective dock; and
comparing the distances between the location associated with the legged robot and the locations associated with the two or more docks, wherein identifying the first dock is further based on comparing the distances between the location associated with the legged robot and the locations associated with the two or more docks.

8. The method of claim 1, further comprising:
obtaining a map, wherein the map indicates the two or more docks and a second dock, wherein the second dock is associated with a second legged robot, and wherein identifying the first dock is further based on the map.

9. The method of claim 1, further comprising:
determining battery data associated with the legged robot, wherein instructing the legged robot to perform the first docking maneuver is further based on the battery data.

10. The method of claim 1, further comprising:
obtaining mission data associated with the legged robot, the mission data indicative of a mission associated with the legged robot, wherein instructing the legged robot to perform the first docking maneuver is further based on the mission data.

11. The method of claim 1, further comprising:
obtaining mission data associated with the legged robot, the mission data indicative of a mission associated with the legged robot, wherein the mission data indicates a set of route waypoints, one or more route edges, and one or more actions, wherein each of the one or more route edges connects two respective waypoints of the set of route waypoints, wherein instructing the legged robot to perform the first docking maneuver is further based on performance of an action of the one or more actions.

12. The method of claim 1, further comprising:
obtaining mission data associated with the legged robot, the mission data indicative of a mission associated with the legged robot, wherein the mission data indicates a set of route waypoints, one or more route edges, and one or more docks; and
generating updated mission data associated with the legged robot, wherein the updated mission data indicates the set of route waypoints, the one or more route edges, the one or more docks, and the first dock, wherein instructing the legged robot to perform the first docking maneuver is further based on the updated mission data.

13. The method of claim 1, further comprising:
generating mission data associated with the legged robot, the mission data indicative of a mission associated with the legged robot, wherein the mission data indicates a set of route waypoints, one or more route edges, and the two or more docks, wherein the mission further indicates, for each respective dock of the two or more docks, that the respective dock comprises a mission continuation dock or a mission termination dock, and wherein instructing the legged robot to perform the first docking maneuver is further based on the mission data.

14. The method of claim 1, further comprising:
obtaining mission data associated with the legged robot, the mission data indicative of a mission associated with the legged robot, wherein the mission data indicates a set of route waypoints, one or more route edges, and one or more actions, wherein each of the one or more route edges connects two respective waypoints of the set of route waypoints, wherein instructing the legged robot to perform the first docking maneuver is further based on an anomaly associated with performance of an action of the one or more actions.

15. The method of claim 1, wherein instructing the legged robot to perform the first docking maneuver comprises:
instructing the legged robot to dock at the first dock; and
instructing the legged robot to traverse the environment of the legged robot based on docking at the first dock or terminate a mission of the legged robot based on docking at the first dock.

16. The method of claim 1, further comprising:
instructing display of a user interface via a user computing device, wherein the user interface indicates the two or more docks; and
obtaining, from the user computing device, an input, wherein the input indicates a selection of the first dock from the two or more docks, wherein identifying the first dock is further based on the selection.

17. The method of claim 1, further comprising:
obtaining one or more dock identifiers based on the dock association data, the one or more dock identifiers indicate the two or more docks;
obtaining mission data associated with the legged robot, the mission data indicative of a mission associated with the legged robot, wherein the mission data indicates a set of route waypoints, one or more route edges, and one or more actions, wherein each of the one or more route edges connects two respective waypoints of the set of route waypoints;
determining that a route edge of the one or more route edges is obstructed;
updating the one or more dock identifiers based on determining that the route edge is obstructed to obtain one or more updated dock identifiers, wherein identifying the first dock is further based on the mission data;
updating the mission data based on determining that the route edge is obstructed to obtain updated mission data; and
resetting the one or more dock identifiers based on at least one of the one or more updated dock identifiers or the updated mission data.

18. The method of claim 1, further comprising:
identifying a set of docks in the environment of the legged robot; and
instructing display of a user interface via a user computing device, wherein the user interface indicates the set of docks,
wherein obtaining the dock association data comprises:
obtaining the dock association data from the user computing device based on a selection of the two or more docks from the set of docks.

19. The method of claim 1, further comprising:
identifying performance of a second docking maneuver relative to the first dock; and
generating the dock association data based on the performance of the second docking maneuver.

20. A system comprising:
data processing hardware; and
memory in communication with the data processing hardware, the memory storing instructions that when execute on the data processing hardware cause the data processing hardware to:
obtain first sensor data associated with an environment of a legged robot;
obtain dock association data associated with the legged robot, wherein the dock association data indicates an association of two or more docks to the legged robot;
identify a first dock of the two or more docks based on the dock association data; and
instruct the legged robot to perform a first docking maneuver relative to the first dock based on the first sensor data and identifying the first dock.

21. The system of claim 20, wherein execution of the instructions on the data processing hardware further causes the data processing hardware to:
obtain a dynamic association of the two or more docks to the legged robot; and
generate the dock association data based on the dynamic association of the two or more docks to the legged robot.

22. The system of claim 20, wherein execution of the instructions on the data processing hardware further causes the data processing hardware to:
obtain one or more dock identifiers based on the dock association data, the one or more dock identifiers indicate the two or more docks;
identify an anomaly associated with a second docking maneuver relative to a second dock of the two or more docks; and
update the one or more dock identifiers to remove an identifier of the second dock from the one or more dock identifiers based on identifying the anomaly.

23. A legged robot comprising:
data processing hardware; and
memory in communication with the data processing hardware, the memory storing instructions that when execute on the data processing hardware cause the data processing hardware to:
obtain first sensor data associated with an environment of the legged robot;
obtain dock association data associated with the legged robot, wherein the dock association data indicates an association of two or more docks to the legged robot;
identify a first dock of the two or more docks based on the dock association data; and
instruct the legged robot to perform a first docking maneuver relative to the first dock based on the first sensor data and identifying the first dock.

24. The legged robot of claim 23, wherein execution of the instructions on the data processing hardware further causes the data processing hardware to:
obtain second sensor data;
generate a pictorial representation of the environment of the legged robot based on the second sensor data and the dock association data, wherein the pictorial representation indicates an association status of a second dock in the environment, wherein the association status indicates that the second dock is associated with the legged robot or is associated with a different legged robot; and
instruct display of the pictorial representation via a user computing device.

25. The legged robot of claim 23, wherein execution of the instructions on the data processing hardware further causes the data processing hardware to:
obtain one or more dock identifiers based on the dock association data, the one or more dock identifiers indicate the two or more docks;
determine that access to a second dock of the two or more docks is obstructed; and
update the one or more dock identifiers to remove an identifier of the second dock from the one or more dock identifiers based on determining that access to the second dock is obstructed.
